(19) United States
(12) Patent Application Publication
(10) Pub. No.: US 2025/0172900 A1
(43) Pub. Date: May 29, 2025

(54) IMAGE FORMING APPARATUS

(71) Applicant: BROTHER KOGYO KABUSHIKI KAISHA, Nagoya (JP)

(72) Inventors: Shota SHINOYA, Nisshin (JP); Tomoyuki MIZUNO, Nagoya (JP); Hiroyuki SHINGAI, Nagoya (JP); Tatsuya KOYAMA, Toyoake (JP)

(73) Assignee: BROTHER KOGYO KABUSHIKI KAISHA, Nagoya (JP)

(21) Appl. No.: 19/039,398

(22) Filed: Jan. 28, 2025

Related U.S. Application Data
(63) Continuation of application No. PCT/JP2023/026197, filed on Jul. 18, 2023.

(30) Foreign Application Priority Data
Jul. 29, 2022 (JP) 2022-121593
Dec. 28, 2022 (JP) 2022-212590

(51) Int. Cl. G03G 15/00; G03G 15/20

(52) U.S. Cl. CPC G03G 15/6582; G03G 15/2064; G03G 15/5029; G03G 15/6552; G03G 15/6573; G03G 2215/00734; G03G 2215/00814

(57) ABSTRACT

An image forming apparatus includes: an apparatus main body; a cutter capable of cutting sheets; a first discharge roller configured to discharge a sheet, which is not cut by the cutter, to the outside of the apparatus main body; and a second discharge roller configured to discharge a sheet, which is cut by the cutter, to the outside of the apparatus main body. The second discharge roller is located downstream of the first discharge roller in a discharge direction of the sheet from the first discharge roller.

### REFERENCE TO RELATED APPLICATIONS

This is a continuation application of International Application No. PCT/JP2023/026197 filed on Jul. 18, 2023, which claims priority from Japanese Patent Application No. 2022-121593 filed on Jul. 29, 2022 and Japanese Patent Application No. 2022-212590 filed on Dec. 28, 2022. The entire contents of the aforementioned applications are incorporated herein by reference.

### BACKGROUND ART

In the related art, an image forming apparatus including a cutter has been known. The image forming apparatus can cut one sheet into two portions when determining that the sheet needs to be cut. The cut sheet is discharged to the same location as a sheet that is not cut.

### SUMMARY

However, in the image forming apparatus in the related art, the cut sheet and the uncut sheet are discharged to the same location, and thus there is a problem that it is difficult to take the cut sheet compared to the uncut sheet.

Therefore, an object of the present invention is to make it easy to take a cut sheet.

An image forming apparatus for achieving the above object includes an apparatus main body, a cutter, a first discharge roller, and a second discharge roller. The cutter is capable of cutting sheets. The first discharge roller discharges a sheet, which is not cut by the cutter, to the outside of the apparatus main body. The second discharge roller discharges a sheet, which is cut by the cutter, to the outside of the apparatus main body. The second discharge roller is located downstream of the first discharge roller in a discharge direction of the sheet from the first discharge roller.

An image forming apparatus for achieving the above object includes an apparatus main body, a cutter, a first discharge port, and a second discharge port. The cutter is capable of cutting sheets. A sheet, which is not cut by the cutter, is discharged to the outside of the apparatus main body through the first discharge port. A sheet, which is cut by the cutter, is discharged to the outside of the apparatus main body through the second discharge port. The second discharge port is located downstream of the first discharge port in a discharge direction of the sheet discharged from the first discharge port.

Further, a configuration may be adopted in which an image forming unit; a first conveying path that guides the sheet on which an image is formed by the image forming unit to the outside of the apparatus main body, and through which the sheet, which is not cut by the cutter, passes; and a second conveying path that is different from the first conveying path and guides the sheet on which the image is formed by the image forming unit to the outside of the apparatus main body, and through which the sheet, that is cut by the cutter, passes are included, and the cutter is disposed in the second conveying path.

Further, a configuration may be adopted in which an image forming unit; a first conveying path that guides the sheet on which an image is formed by the image forming unit to the outside of the apparatus main body, and through which the sheet, which is not cut by the cutter, passes; and a second conveying path that is different from the first conveying path and guides the sheet on which the image is formed by the image forming unit to the outside of the apparatus main body, and through which the sheet, which is cut by the cutter, passes are included, and the second conveying path is a conveying path longer than the first conveying path.

Further, a configuration may be adopted in which an image forming unit; a first conveying path that guides the sheet on which an image is formed by the image forming unit to the outside of the apparatus main body, and through which the sheet, which is not cut by the cutter, passes; a second conveying path that is different from the first conveying path and guides the sheet on which the image is formed by the image forming unit to the outside of the apparatus main body, and through which the sheet, which is cut by the cutter, passes; a fixing unit that includes a heating rotation body and a pressure rotation body forming a nip portion between the heating rotation body and the pressure rotation body, and fixes the image onto the sheet; and a flapper movable between a first position at which the sheet that has passed through the fixing unit is guided to the first conveying path and a second position at which the sheet that has passed through the fixing unit is guided to the second conveying path are included.

Further, a configuration may be adopted in which a fixing unit that includes a heating rotation body and a pressure rotation body forming a nip portion between the heating rotation body and the pressure rotation body, and fixes an image onto the sheet is further included, and the first discharge roller is located closer to the fixing unit than the second discharge roller.

Further, a configuration may be adopted in which a fixing unit that includes a heating rotation body and a pressure rotation body forming a nip portion between the heating rotation body and the pressure rotation body, and fixes an image onto the sheet is further included, and the first discharge port is located closer to the fixing unit than the second discharge port.

Further, a configuration may be adopted in which a conveying roller that is located upstream of the cutter in a conveying direction of the sheet and conveys the sheet to the cutter is further included, and dimensions of the second discharge roller and the conveying roller in an axial direction are larger than half of a width of a sheet having a maximum width and capable of being conveyed by the image forming apparatus.

Further, a configuration may be adopted in which the dimension of at least one of the second discharge roller and the conveying roller in the axial direction is larger than the width of the sheet having the maximum width and capable of being conveyed by the image forming apparatus.

Further, a configuration may be adopted in which an image forming unit; a first conveying path that guides the sheet on which an image is formed by the image forming unit to the outside of the apparatus main body, and through which the sheet, which is not cut by the cutter, passes; a second conveying path that is different from the first conveying path and guides the sheet on which the image is formed by the image forming unit to the outside of the apparatus main body, and through which the sheet, which is cut by the cutter, passes; a sensor that is disposed in a sheet conveying path and is capable of detecting the presence or absence of the sheet; and a controller are further included, and the controller acquires a dimension of the sheet in a conveying direction based on a detection signal from the sensor, and conveys the sheet to the second conveying path and discharges the sheet to the outside of the apparatus main body without cutting the sheet when determining that the dimension of the sheet in the conveying direction is smaller than a predetermined value.

Further, a configuration may be adopted in which an image forming unit; a first conveying path that guides the sheet on which an image is formed by the image forming unit to the outside of the apparatus main body, and through which the sheet, which is not cut by the cutter passes; a second conveying path that is different from the first conveying path and guides the sheet on which the image is formed by the image forming unit to the outside of the apparatus main body, and through which the sheet, which is cut by the cutter, passes; and a controller are further included, and when determining that a dimension of a sheet included in a received print job in a conveying direction of the sheet is smaller than a predetermined value, the controller conveys the sheet to the second conveying path and discharges the sheet to the outside of the apparatus main body without cutting the sheet.

Further, a configuration may be adopted in which an image forming unit; a first conveying path that guides the sheet on which an image is formed by the image forming unit to the outside of the apparatus main body, and through which the sheet, which is not cut by the cutter, passes; a second conveying path that is different from the first conveying path and guides the sheet on which the image is formed by the image forming unit to the outside of the apparatus main body, and through which the sheet, which is cut by the cutter, passes; a first discharge tray on which the sheet discharged through the first conveying path is allowed to stack; and a second discharge tray on which the sheet discharged through the second conveying path is allowed to stack are further included.

Further, a configuration may be adopted in which an image forming unit includes a photosensitive drum, a developing roller that supplies a toner onto the photosensitive drum, and a transfer roller that transfers the toner supplied onto the photosensitive drum to the sheet.

An image forming apparatus for achieving the above object includes an image forming unit, a discharge tray, a cutter, a first conveying path, a first discharge roller, a second conveying path, and a second discharge roller. The image forming unit forms an image on a sheet. The discharge tray receives the sheet on which the image is formed. The cutter is capable of cutting the sheet. The first conveying path guides the sheet on which the image is formed, and a sheet that is not cut by the cutter passes through the first conveying path. The first discharge roller is disposed in the first conveying path and discharges the uncut sheet to the discharge tray. The cutter is disposed in the second conveying path, the second conveying path guides the sheet on which the image is formed by the image forming unit, and a sheet that is cut by the cutter passes through the second conveying path. The second discharge roller is disposed in the second conveying path and discharges the cut sheet to the discharge tray. An upstream end of the sheet discharged from the second discharge roller in a discharge direction is located downstream in the discharge direction with respect to an upstream end of the sheet discharged from the first discharge roller in the discharge direction.

Further, a configuration may be adopted in which a discharge tray on which the sheets discharged from the first discharge roller and the second discharge roller are stacked is further included, the discharge tray has a placement surface on which the discharged sheets are placed, and the length of a shortest distance in a direction along the placement surface from a first end of the placement surface on an upstream side in the discharge direction to a reference point of the placement surface located below the second discharge roller in a vertical direction is smaller than a sheet length of the sheet discharged from the second discharge roller.

Further, a standing wall protruding upward from the first end of the placement surface may be further included.

Further, the placement surface may have an inclined surface formed between the first end and a second end opposite to the first end such that the first end is located below the second end.

Further, the placement surface may have a horizontal surface formed on a second end side with respect to the inclined surface, and the horizontal surface may be located below the second discharge roller.

Further, a first conveying path in which the first discharge roller is disposed and that guides a sheet on which an image is formed to the first discharge roller; and a second conveying path in which the second discharge roller and the cutter are disposed and that guides the sheet on which the image is formed to the second discharge roller may be further included.

Further, a first stack lever that is pivotally provided with respect to the apparatus main body, extends toward the placement surface, and is capable of coming into contact with the sheet discharged to the discharge tray by the first discharge roller; and a second stack lever that is pivotally provided with respect to the apparatus main body, extends toward the placement surface, and is capable of coming into contact with the sheet discharged to the discharge tray by the second discharge roller may be further included, and the second discharge roller may be disposed above an upper limit position that is an upper extreme position in a pivot range of the first stack lever.

Further, the first stack lever may be disposed at a position corresponding to a third end side which is one side in a width direction of the placement surface, the width direction being a direction orthogonal to the discharge direction, and a third stack lever may be disposed at a position corresponding to a fourth end side which is the other side.

Further, the second stack lever may be disposed at a position corresponding to a central portion of the placement surface in a width direction of the placement surface which is a direction orthogonal to the discharge direction.

Further, a static elimination brush may be provided downstream of the second discharge roller in the discharge direction and may be provided to come into contact with the sheet discharged by the second discharge roller and eliminate static electricity charged on the sheet.

Further, the discharge tray may include a stopper that protrudes upward from a second end side opposite to the first end of the placement surface and has a contact surface capable of coming into contact with the discharged sheet, and the length from the second discharge roller to the contact surface in the discharge direction may be larger than a maximum sheet length of the cut sheet discharged by the second discharge roller.

Further, the image forming unit includes a photosensitive drum, a developing roller that supplies a toner onto the photosensitive drum, a transfer roller that transfers the toner supplied onto the photosensitive drum to the sheet, and a fixing device that includes a pressure rotation body and a heating rotation body and fixes the toner transferred to the sheet on the sheet.

Further, the reference point of the placement surface may be an end point on a downstream side in the discharge direction in a region projected on the placement surface when the second discharge roller is projected toward the placement surface from above in the vertical direction.

An image forming apparatus according to the present disclosure is an image forming apparatus capable of discharging sheets having different sheet lengths in a conveying direction as a direction in which the sheets are conveyed, the image forming apparatus includes: an apparatus main body; a discharge tray provided in the apparatus main body and having a placement surface on which the discharged sheets are placed; a plurality of conveying rollers that convey the sheets along the conveying direction; an image forming unit that forms an image on each of the sheets; a first discharge roller that discharges a sheet on which the image is formed by the image forming unit to the discharge tray; and a second discharge roller that discharges, to the discharge tray, a sheet on which the image is formed by the image forming unit and having the sheet length smaller than the sheet length of the sheet discharged by the first discharge roller, the second discharge roller is disposed at a position downstream of and above the first discharge roller in a discharge direction as a direction in which the sheets are discharged, and the length of a shortest distance in a direction along the placement surface from a first end of the placement surface on a first discharge roller side in the discharge direction to a reference point of the placement surface, which serves as a position corresponding to a lower side of the second discharge roller in a vertical direction, is smaller than the length in the conveying direction from the second discharge roller to the conveying roller located at a position closest to the second discharge roller in the conveying direction.

### BRIEF DESCRIPTION OF THE DRAWINGS

FIG. 1 is a diagram showing a configuration of an image forming apparatus.

FIG. 2 is a perspective view of a cutter.

FIG. 3 is a partially enlarged view of FIG. 2.

FIG. 4 is a diagram showing a conveying distance from a nip portion to the cutter.

FIG. 5 is a diagram for comparing dimensions of a sheet, a switchback roller, and a second discharge roller in an axial direction.

FIG. 6 is a diagram showing electrical connection among a controller, respective motors, a flapper, and respective sensors.

FIG. 7 is a flowchart showing an example of a process executed by the controller after a job is received.

FIG. 8 is a time chart for explaining timings of sheet feeding, sheet conveyance, and cutting controlled by the controller.

FIG. 9 is a diagram showing the image forming apparatus in which the cut sheet is discharged.

FIG. 10 is a diagram showing an image forming apparatus including a second discharge tray.

FIG. 11 is a diagram showing an image forming apparatus including a scanner unit.

FIG. 12A shows the sheet cut into two portions by the cutter, and FIG. 12B shows the discharged sheet and the sheet guided to a re-conveying path.

FIGS. 13A to 13C are diagrams for explaining a movement of the sheet in a trailing end avoiding control, FIG. 13A shows a state in which a trailing end of the sheet is located at the nip portion, FIG. 13B shows a state in which an expected cutting point of the sheet is located downstream of the cutter, and FIG. 13C shows a state in which the trailing end of the sheet enters the re-conveying path.

FIG. 14 is a flowchart showing an example of a process executed by the controller according to a modification.

FIG. 15 is a time chart for explaining timings of sheet feeding, sheet conveyance, and cutting according to the modification.

FIG. 16 is a diagram showing a schematic configuration of an image forming apparatus.

FIG. 17 is a block diagram showing an electrical configuration of the image forming apparatus.

FIGS. 18A and 18B are diagrams for explaining the cutting of the sheet by the cutter.

FIG. 19 is a view for explaining a dispositional relation between a placement surface of a discharge tray and respective members in the vicinity of a first discharge port and a second discharge port.

FIG. 20 is a perspective view showing a schematic configuration of the cutter.

FIG. 21 is a diagram showing a schematic configuration of an image forming apparatus.

### DESCRIPTION

### Embodiment 1

Next, Embodiment 1 of the present disclosure will be described in detail with reference to the drawings as appropriate.

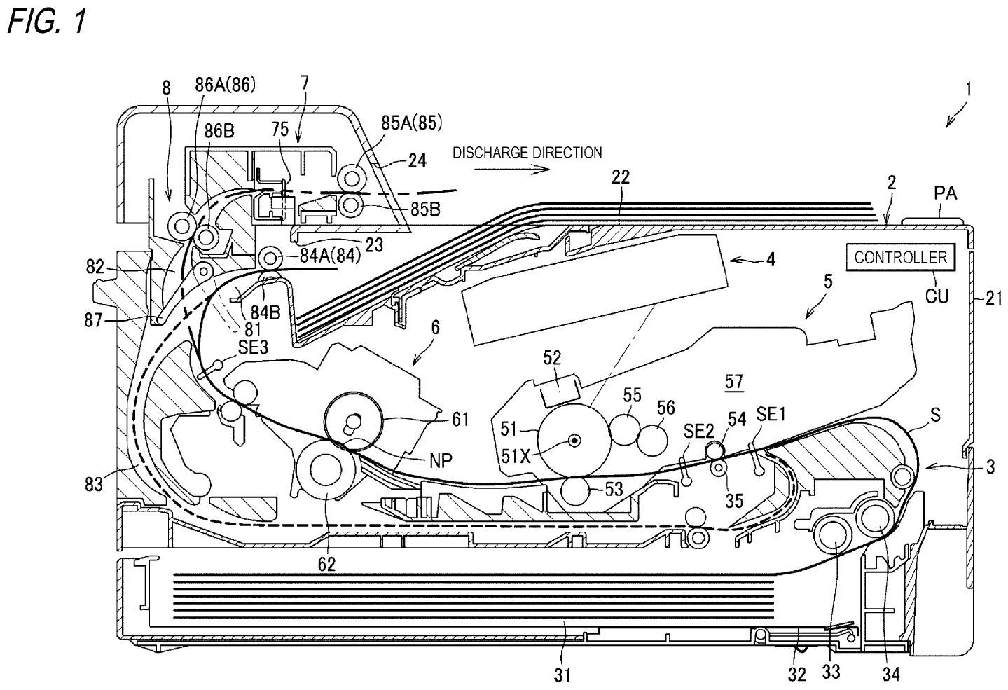

In the following description, an axial direction of a photosensitive drum 51 is referred to as an “axial direction”. A discharge direction of a sheet S discharged by a first discharge roller 84 (a direction indicated by the arrow in FIG. 1) is referred to as a “discharge direction”.

As shown in FIG. 1, an image forming apparatus 1 refers to a laser printer.

The image forming apparatus 1 includes an apparatus main body 2, a feed unit 3, an exposure device 4, a drum cartridge 5, a fixing unit 6, a cutter 7, a sheet conveying unit 8, an operation panel PA as an example of an input unit, a sensor SE, and a controller CU. The exposure device 4 and the drum cartridge 5 are examples of an image forming unit, and form an image on the sheet S.

The apparatus main body 2 includes a front cover 21, a discharge tray 22, a first discharge port 23, and a second discharge port 24. The front cover 21 is located downstream in the discharge direction in the apparatus main body 2. The discharge tray 22 is formed on an upper surface of the apparatus main body 2. The discharge tray 22 is a tray on which discharged sheets are placed. The front cover 21 can be opened to expose the inside of the apparatus or closed to close the inside of the apparatus in order to remove a sheet jammed inside the apparatus or to replace the drum cartridge 5. Therefore, the front cover 21 is provided on a front surface of the apparatus to be easily operated by a user.

The first discharge port 23 is a discharge port for discharging the sheet S to the outside of the apparatus main body 2. The first discharge port 23 is located below the second discharge port 24. In other words, the first discharge port 23 is located closer to the fixing unit 6 to be described later than the second discharge port 24. In the present embodiment, the first discharge port 23 discharges the sheet S, which is not cut by the cutter 7, to the outside of the apparatus main body 2. The sheet S discharged from the first discharge port 23 is placed on the discharge tray 22.

The second discharge port 24 is a discharge port different from the first discharge port 23 for discharging the sheet S to the outside of the apparatus main body 2. The second discharge port 24 is located above and downstream of the first discharge port 23 in the discharge direction. In the present embodiment, the second discharge port 24 mainly discharges the sheet S, which is cut by the cutter 7, to the outside of the apparatus main body 2. The sheet S discharged from the second discharge port 24 is placed on the discharge tray 22.

The feed unit 3 is located inside the apparatus main body 2. The feed unit 3 includes a feed tray 31, a sheet pressing plate 32, a pickup roller 33, a separation roller 34, and a registration roller 35.

The feed tray 31 is a tray on which the sheet S is placed. The sheet pressing plate 32 pushes upward the sheet S in the feed tray 31. The pickup roller 33 picks up the sheet S in the feed tray 31. The separation roller 34 separates the sheet S picked up by the pickup roller 33 one by one. The registration roller 35 conveys the sheet S between the photosensitive drum 51 and a transfer roller 53.

The exposure device 4 is located at an upper portion inside the apparatus main body 2. The exposure device 4 includes a laser emitter, a polygon mirror, a lens, a reflective mirror, and the like, which are not shown. In the exposure device 4, a laser beam (see a chain line) based on image data emitted from the laser emitter is scanned at a high speed on a surface of the photosensitive drum 51 to expose the surface of the photosensitive drum 51.

The drum cartridge 5 is attachable to and detachable from the apparatus main body 2. When the drum cartridge 5 is attached to the apparatus main body 2, the drum cartridge 5 is located below the exposure device 4. The drum cartridge 5 is attached and detached in a state in which the front cover 21 is opened.

The drum cartridge 5 includes the photosensitive drum 51, a charger 52, the transfer roller 53, a pinch roller 54, a developing roller 55, a feed roller 56, and a toner containing portion 57.

The photosensitive drum 51 is rotatable about a drum shaft 51X extending in a first direction. The charger 52 charges the surface of the photosensitive drum 51. The transfer roller 53 is located to face the photosensitive drum 51. The transfer roller 53 transfers a toner image formed on the photosensitive drum 51 to the sheet S. The charger 52 is a scorotron charger. The pinch roller 54 is located to face the registration roller 35. The pinch roller 54 rotates following the rotation of the registration roller 35 to convey the sheet S together with the registration roller 35.

The developing roller 55 feeds the toner to the photosensitive drum 51 in a state of being in contact with the photosensitive drum 51. The feed roller 56 feeds the toner in the toner containing portion 57 to the developing roller 55.

In the drum cartridge 5, the surface of the photosensitive drum 51 is uniformly charged by the charger 52. Thereafter, the surface of the photosensitive drum 51 is exposed by the high-speed scanning of the laser beam from the exposure device 4, so that an electrostatic latent image based on the image data is formed on the photosensitive drum 51. The toner carried on the developing roller 55 is fed from the developing roller 55 to the electrostatic latent image formed on the photosensitive drum 51. As a result, the electrostatic latent image is visualized, and the toner image is formed on the photosensitive drum 51. Thereafter, the sheet S is conveyed between the photosensitive drum 51 and the transfer roller 53, so that the toner image on the photosensitive drum 51 is transferred onto the sheet S.

The fixing unit 6 is located behind the drum cartridge 5. The fixing unit 6 includes a heating unit 61 as an example of a heating rotation body and a pressure roller 62 as an example of a pressure rotation body. The heating unit 61 includes a halogen heater, a fixing belt, a nip plate, and the like without reference symbols. The pressure roller 62 sandwiches the fixing belt between the pressure roller 62 and the nip plate of the heating unit 61. The pressure roller 62 forms a nip portion NP between the pressure roller 62 and the heating unit 61. In the fixing unit 6, the toner image transferred onto the sheet S is thermally fixed onto the sheet S when the sheet S passes between the heating unit 61 and the pressure roller 62.

The cutter 7 is capable of cutting the sheet S and is located at an upper portion of the apparatus main body 2. In the present embodiment, the cutter 7 is disposed in a second conveying path 82 to be described later.

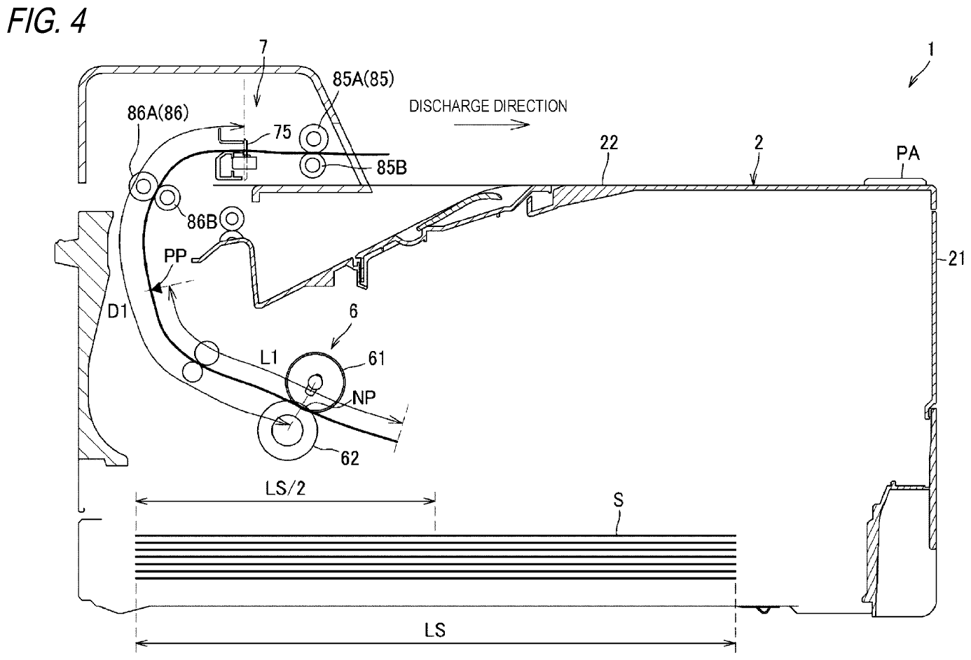

As shown in FIG. 4, the cutter 7 is capable of cutting the sheet S having at least letter size at a center position of the sheet in a conveying direction. A conveying distance D1 by which the sheet S is conveyed from the nip portion NP to the cutter 7 is larger than half of a dimension LS of the sheet S having the letter size in the conveying direction (D1>LS/2). Since the sheet S having the letter size is 215.9 mm×279.4 mm, the half of the dimension LS of the sheet having the letter size in the conveying direction is 139.7 mm.

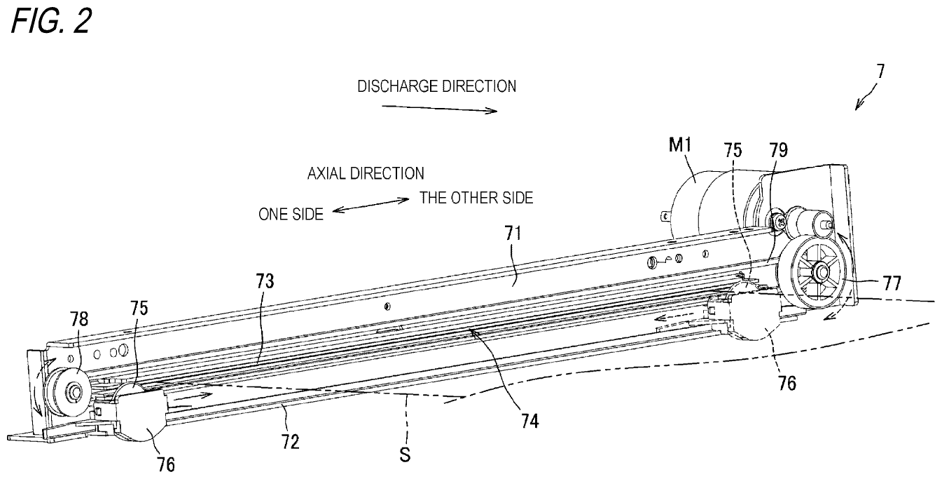

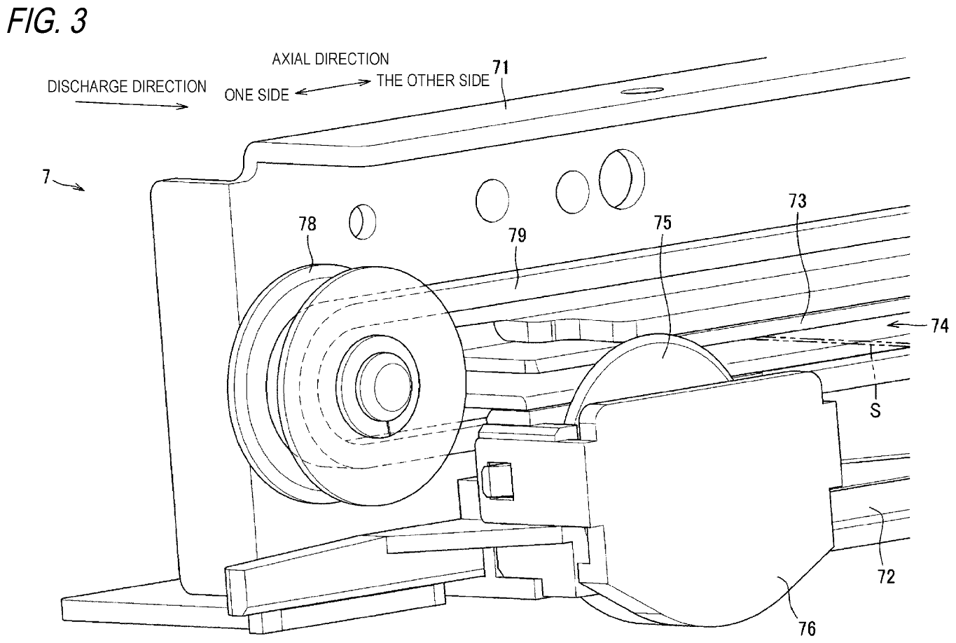

As shown in FIGS. 2 and 3, the cutter 7 includes a cutter frame 71, a slide rail 72, a fixed blade 73, a sheet passing portion 74, a moving blade 75, a slide holder 76, a drive pulley 77, a driven pulley 78, a pulley belt 79, and a cutting motor M1.

The cutter frame 71 extends in the axial direction. The slide rail 72 is a rail that is formed on the cutter frame 71 and extends in the axial direction. The fixed blade 73 is a flat plate-shaped blade that is fixed to the cutter frame 71 and extends in the axial direction. The sheet passing portion 74 is a space that is formed in the cutter frame 71 and through which the sheet S passes. In the present embodiment, the sheet passing portion 74 is formed between the slide rail 72 and the fixed blade 73. The moving blade 75 is a circular plate-shaped blade, and is rotatably fixed to the slide holder 76.

The slide holder 76 is engaged with the slide rail 72, and is slidably attached to the cutter frame 71 along the slide rail 72. The slide holder 76 is movable from an initial position indicated by a solid line to a cutting completion position indicated by a broken line in FIG. 2. Before the sheet S is cut, the slide holder 76 is located at the initial position indicated by the solid line in FIG. 2. When the slide holder 76 moves to the cutting completion position along the slide rail 72, one sheet S is sandwiched between the fixed blade 73 and the moving blade 75 and is cut into two portions. The slide holder 76 is returned from the cutting completion position to the initial position before the next sheet S starts to be cut.

The drive pulley 77 is disposed on the other side of the cutter frame 71 in the axial direction. The drive pulley 77 can rotate in forward and reverse directions by receiving a drive force of the cutting motor M1. The driven pulley 78 is disposed on one side of the cutter frame 71 in the axial direction. The pulley belt 79 is wound around the drive pulley 77 and the driven pulley 78. Further, the slide holder 76 is fixed to the pulley belt 79. As a result, the slide holder 76 slides in the axial direction in accordance with the rotation of the pulley belt 79. In detail, when the cutting motor M1 is rotated in the forward direction, the slide holder 76 slides from one side to the other side in the axial direction, and when the cutting motor M1 is rotated in the reverse direction, the slide holder 76 slides from the other side to one side in the axial direction.

When cutting the sheet S, the cutter 7 rotates the cutting motor M1 in the forward direction to move the slide holder 76 located at the initial position toward the cutting completion position.

Then, the moving blade 75 moves together with the slide holder 76, and thus the sheet S located at the sheet passing portion 74 is sandwiched between the fixed blade 73 and the moving blade 75 and is cut.

When the slide holder 76 is located at the cutting completion position, the cutting motor M1 stops. After the cut sheet S is discharged, the cutting motor M1 rotates in the reverse direction, and the slide holder 76 is returned from the cutting completion position to the initial position.

Returning to FIG. 1, the sheet conveying unit 8 has a function of conveying the sheet S on which the image is formed to the outside of the apparatus main body 2 or to the image forming unit again. The sheet conveying unit 8 includes a first conveying path 81, the second conveying path 82, a re-conveying path 83, the first discharge roller 84, a second discharge roller 85, a switchback roller 86 as an example of a conveying roller, and a flapper 87.

The first conveying path 81 is a path for guiding the sheet S on which the image is formed to the outside of the apparatus main body 2. Specifically, the first conveying path 81 is a path from the flapper 87 to the first discharge port 23. In the present embodiment, the sheet S, which is not cut by the cutter 7, passes through the first conveying path 81.

The second conveying path 82 is a path different from the first conveying path 81. The second conveying path 82 is a path for guiding a sheet on which an image is formed by the image forming unit to the outside of the apparatus main body 2. Specifically, the second conveying path 82 is a path from the flapper 87 to the second discharge port 24. In the present embodiment, the sheet, which is cut by the cutter 7, mainly passes through the second conveying path 82. The second conveying path 82 is a conveying path longer than the first conveying path 81.

As shown by the sheet S that is indicated by the broken line in FIG. 1, the re-conveying path 83 is a path for guiding the sheet that has passed through the fixing unit 6 to the image forming unit again. Specifically, the re-conveying path 83 is a path from the flapper 87 to the drum cartridge 5 through below the fixing unit 6.

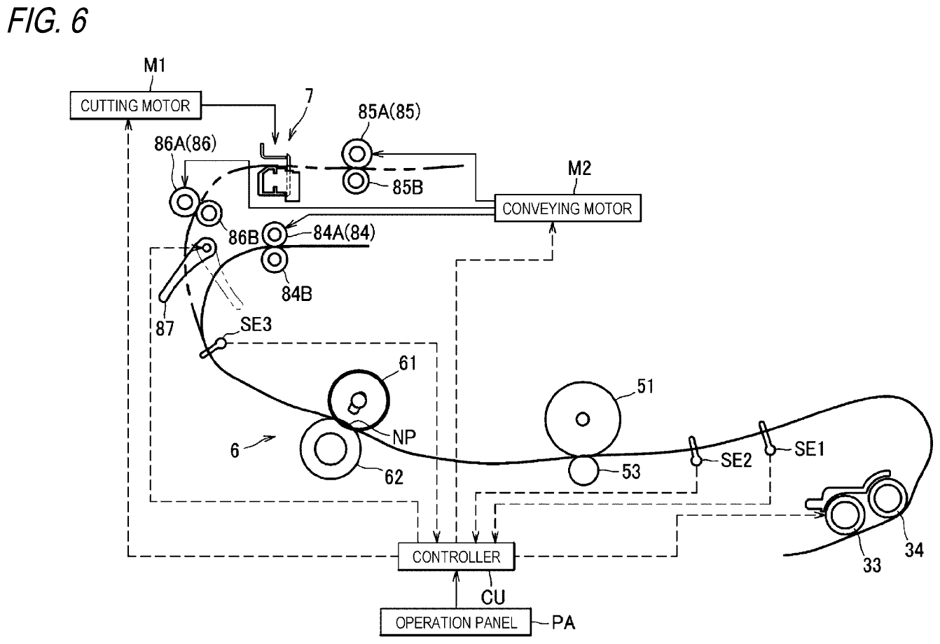

The first discharge roller 84 is a roller that is disposed in the first conveying path 81 and discharges the sheet S to the outside of the apparatus main body 2. In the present embodiment, the first discharge roller 84 refers to a roller pair arranged in an up-down direction, and includes a drive roller 84A and a driven roller 84B. The first discharge roller 84 is rotatable about an axis parallel to the axial direction. The first discharge roller 84 discharges the sheet S, which is not cut by the cutter 7, to the outside of the apparatus main body 2. The first discharge roller 84 is located closer to the fixing unit 6 than the second discharge roller 85. The first discharge roller 84 is rotatable by driving of a conveying motor M2 (see FIG. 6).

The second discharge roller 85 is a roller that is disposed in the second conveying path 82 and discharges the sheet S to the outside of the apparatus main body 2. In the present embodiment, the second discharge roller 85 refers to a roller pair arranged in the up-down direction, and includes a drive roller 85A and a driven roller 85B. The second discharge roller 85 is rotatable in the axial direction. The second discharge roller 85 mainly discharges the sheet S, which is cut by the cutter 7, to the outside of the apparatus main body 2. The second discharge roller 85 is located above and downstream of the first discharge roller 84 in the discharge direction of the sheet S. The second discharge roller 85 is rotatable by the driving of the conveying motor M2. A conveying speed of the sheet S by the second discharge roller 85 is higher than a conveying speed by the switchback roller 86.

The switchback roller 86 is a roller that is disposed in the second conveying path 82 and conveys the sheet S. The switchback roller 86 is located between the flapper 87 and the cutter 7. In the present embodiment, the switchback roller 86 refers to a roller pair, and includes a drive roller 86A and a driven roller 86B. The switchback roller 86 is rotatable in the forward and reverse directions by the driving of the conveying motor M2. When the conveying motor M2 rotates in the forward direction, the switchback roller 86 conveys the sheet S having passed through the flapper 87 toward the cutter 7. Further, when the conveying motor M2 rotates in the reverse direction, the switchback roller 86 conveys the sheet S located in the second conveying path 82 to the re-conveying path 83.

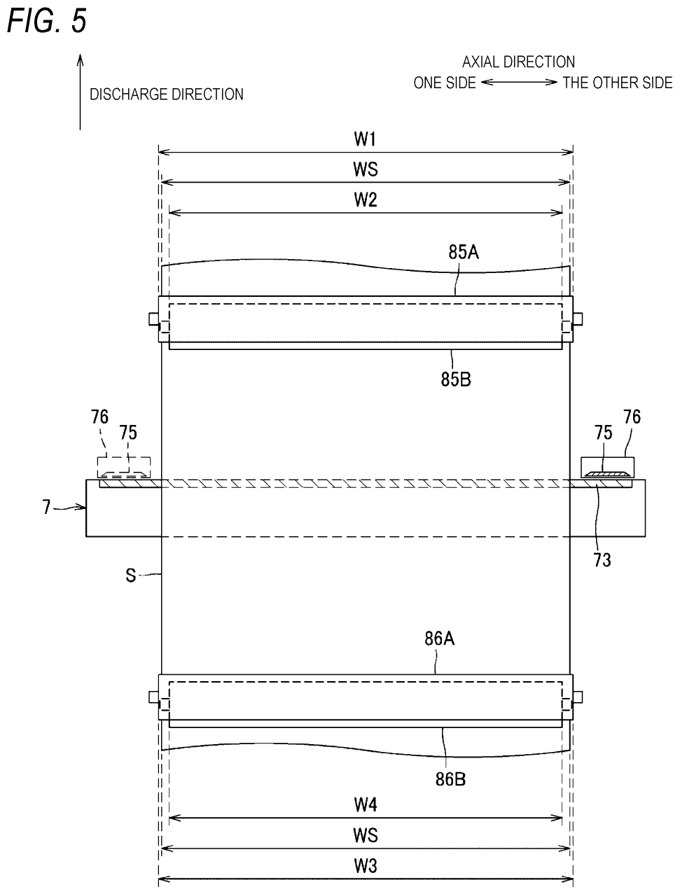

As shown in FIG. 5, a dimension W1 of the drive roller 85A of the second discharge roller 85 in the axial direction is larger than half of a width WS of the sheet S having a maximum width and capable of being conveyed by the image forming apparatus 1 (W1>WS/2). In the present embodiment, the maximum width by which the sheet S can be conveyed by the image forming apparatus 1 is 215.9 mm.

Similarly, a dimension W2 of the driven roller 85B of the second discharge roller 85 in the axial direction is larger than half of the width WS of the sheet S having the maximum width and capable of being conveyed by the image forming apparatus 1 (W2>WS/2). Further, the dimension W1 of the drive roller 85A of the second discharge roller 85 in the axial direction is larger than the width WS of the sheet S having the maximum width and capable of being conveyed by the image forming apparatus 1 (W1>WS). Further, the dimension W2 of the driven roller 85B of the second discharge roller 85 in the axial direction is smaller than the width WS of the sheet S having the maximum width and capable of being conveyed by the image forming apparatus 1 (W2<WS).

A dimension W3 of the drive roller 86A of the switchback roller 86 in the axial direction is larger than half of the width WS of the sheet S having the maximum width and capable of being conveyed by the image forming apparatus 1 (W3>WS/2).

Similarly, a dimension W4 of the driven roller 86B of the switchback roller 86 in the axial direction is larger than half of the width WS of the sheet S having the maximum width and capable of being conveyed by the image forming apparatus 1 (W4>WS/2). Further, the dimension W3 of the drive roller 86A of the switchback roller 86 in the axial direction is larger than the width WS of the sheet S having the maximum width and capable of being conveyed by the image forming apparatus 1 (W3>WS). Further, the dimension W4 of the driven roller 86B of the switchback roller 86 in the axial direction is smaller than the width WS of the sheet S having the maximum width and capable of being conveyed by the image forming apparatus 1 (W4<WS).

The flapper 87 is located at a branch portion between the first conveying path 81 and the second conveying path 82. The flapper 87 is movable between a first position indicated by a solid line in FIG. 1 and a second position indicated by a two-dot chain line in FIG. 1. When the flapper 87 is located at the first position, the flapper 87 guides the sheet S having passed through the fixing unit 6 to the first conveying path 81. When the flapper 87 is located at the second position, the flapper 87 guides the sheet S having passed through the fixing unit 6 to the second conveying path 82.

The sensor SE is a sensor that is disposed in a conveying path of the sheet S and is capable of detecting the presence or absence of the sheet S. Specifically, the sensor SE includes a first sensor SE1, a second sensor SE2, and a third sensor SE3. The first sensor SE1 is located between the separation roller 34 and the registration roller 35 in the conveying direction of the sheet. The first sensor SE1 is located immediately in front of the registration roller 35. The second sensor SE2 is located between the registration roller 35 and the photosensitive drum 51 in the conveying direction of the sheet S. The third sensor SE3 is located between the fixing unit 6 and the flapper 87 in the conveying direction of the sheet S.

The operation panel PA is located on an outer surface of the apparatus main body 2. The operation panel PA allows the user to input a command to form an image, a command to cut the sheet S, and the like. In the present embodiment, for example, the operation panel PA allows to input a cutting point of the sheet S.

The controller CU includes a central processing unit (CPU), a random access memory (RAM), a read only memory (ROM) and an input-output circuit, and controls the image forming apparatus 1 by performing various arithmetic processes based on programs and data stored in the ROM and the like.

As shown in FIG. 6, the controller CU is electrically connected to the first sensor SE1, the second sensor SE2, and the third sensor SE3, and can receive respective detection signals thereof. The controller CU controls the pickup roller 33, the cutting motor M1, the conveying motor M2, and the flapper 87 based on information received from the operation panel PA and the receive sensors.

In principle, the controller CU conveys the sheet S to the first conveying path 81 when the sheet S is not cut by the cutter 7, and conveys the sheet S to the second conveying path 82 when the sheet S is cut by the cutter 7.

When the sheet S is conveyed to the cutter 7, the controller CU starts to rotate the switchback roller 86 after a leading end of the sheet S in the conveying direction comes into contact with the switchback roller 86. Specifically, the controller CU receives a detection signal indicating that the third sensor SE3 detects the leading end of the sheet S. After a predetermined time has elapsed from the reception of the detection signal of the third sensor SE3, the controller CU rotates the conveying motor M2 in the forward direction, and starts the rotation of the switchback roller 86. The predetermined time is a time sufficient for the leading end of the sheet S to come into contact with the switchback roller 86 and the skew of the sheet S to be corrected.

As shown in FIG. 4, when the command to cut the sheet S is received, the controller CU causes the cutter 7 to cut the sheet S in a case in which a dimension L1 in the conveying direction from an expected cutting point PP of the sheet S to a trailing end position EN of the sheet S is smaller than a conveying distance D1 of the sheet S from the nip portion NP to the cutter 7. That is, the controller CU does not cut the sheet S by the cutter 7 in a case in which the dimension L1 in the conveying direction from the expected cutting point PP of the sheet S to the trailing end position EN of the sheet S is equal to or larger than the conveying distance D1 of the sheet S from the nip portion NP to the cutter 7.

The controller CU cuts the sheet S based on the command input to the operation panel PA. Specifically, when the command to cut the sheet S is received, the controller CU cuts the sheet S by the cutter 7 in a state in which the conveyance of the sheet S stops. As an example, when a command to cut the sheet S having the letter size and having the dimension of 215.9 mm in the conveying direction in half is received, two sheets S having the dimension of 139.7 mm in the conveying direction are acquired after the cutting.

The controller CU can acquire the dimension of the sheet S in the conveying direction based on the detection signal from the sensor SE. Specifically, the controller CU may calculate the dimension of the sheet S in the conveying direction based on a passage time during which the sheet S passes through the first sensor SE1. In the present embodiment, the controller CU acquires the dimension of the sheet S based on the detection signal from the first sensor SE1, and may acquire the dimension of the sheet S based on detection signals from other sensors (the second sensor SE2, the third sensor SE3, and the like).

When determining that the dimension of the sheet S in the conveying direction is smaller than a predetermined value based on the detection signal from the sensor SE, the controller CU conveys the sheet S to the second conveying path 82 and discharges the sheet S to the outside of the apparatus main body 2 without cutting the sheet S.

Further, when determining that the dimension of the sheet S in the conveying direction of the sheet S included in a received print job (hereinafter, simply referred to as a “job”) is smaller than the predetermined value, the controller CU conveys the sheet S to the second conveying path 82 and discharges the sheet S to the outside of the apparatus main body 2 without cutting the sheet S.

As described above, when the controller CU determines that the dimension of the sheet S in the conveying direction is smaller than the predetermined value based on the detection signal from the sensor SE or information on the received job, the sheet S is conveyed to the second conveying path 82 even when the sheet S is not cut by the cutter 7.

When a command to cut a plurality of sheets S is received, the controller CU starts to feed the next sheet S before the cutting of the preceding sheet S is completed. The controller CU starts to feed the sheets S by driving the pickup roller 33. When the command to cut a plurality of sheets S is received, the controller CU conveys the sheets S at a predetermined interval between the trailing end of the preceding sheet S and the leading end of the next sheet S.

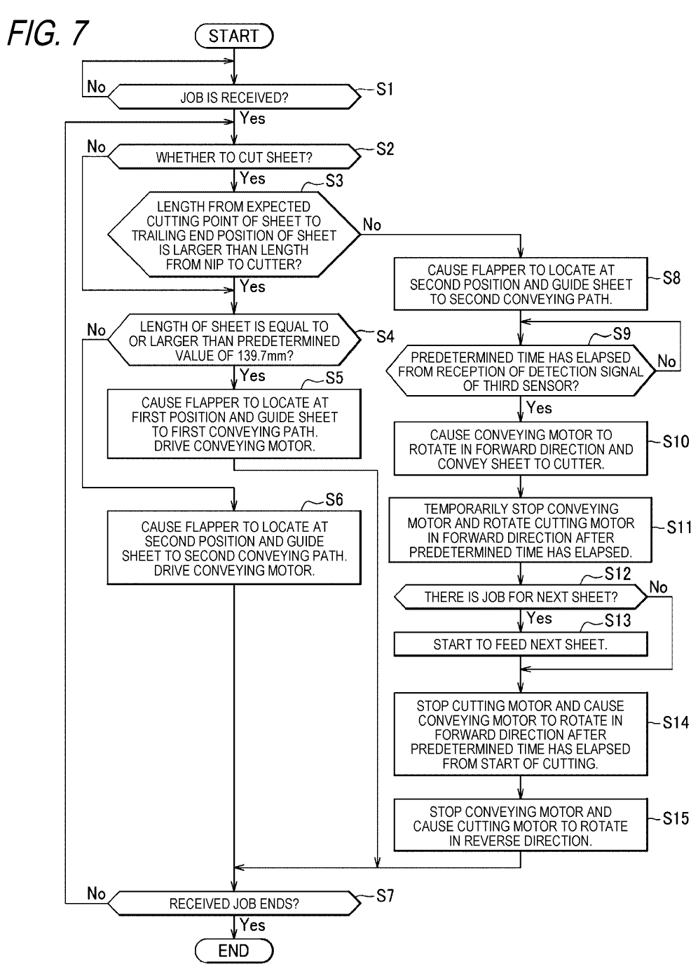

Next, an example of a process executed by the controller CU that receives the job will be described with reference to FIG. 7.

When determining that the job is received (S1, Yes), the controller CU determines whether to cut the sheet S based on the command input from the operation panel PA or the information on the job (S2).

In step S2, when determining to cut the sheet S (S2, Yes), the controller CU determines whether the dimension L1 from the expected cutting point PP to the trailing end position EN of the sheet S is larger than the conveying distance D1 from the nip portion NP to the cutter 7 (L1>D1?) (S3).

When not determining to cut the sheet S in step S2 (S2, No), or when determining in step S3 that the dimension L1 from the expected cutting point PP to the trailing end position EN of the sheet S is larger than the conveying distance D1 from the nip portion NP to the cutter 7 (L1>D1) (S3, Yes), the controller CU determines whether the dimension of the sheet S is equal to or larger than the predetermined value (the dimension of 139.7 mm which is half of the letter size) (S4). Methods of determining the dimension of the sheet S by the controller CU include a method of determining the dimension based on the information on the received job and a method of acquiring the dimension of the sheet S based on a detection result of the sensor SE.

When determining in step S4 that the dimension of the sheet S in the conveying direction is equal to or larger than the predetermined value (137.9 mm) (S4, Yes), the controller CU causes the flapper 87 to locate at the first position, guides the sheet S to the first conveying path 81, and rotates the conveying motor M2 in the forward direction (S5). As a result, the first discharge roller 84 is driven to discharge the sheet from the first discharge port 23.

The controller CU determines whether the received job ends (S7) after step S5, the controller CU ends the process when the received job ends (S7, Yes), and returns to step S2 when the received job does not end (S7, No).

When not determining in step S4 that the dimension of the sheet S in the conveying direction is equal to or larger than the predetermined value (137.9 mm) (S4, No), the controller CU causes the flapper 87 to locate at the second position, guides the sheet S to the second conveying path 82, and rotates the conveying motor M2 in the forward direction (S6).

The controller CU determines whether the received job ends (S7) after step S6, the controller CU ends the process when the received job ends (S7, Yes), and returns to step S2 when the received job does not end (S7, No).

On the other hand, when determining in step S3 that the dimension L1 from the expected cutting point PP to the trailing end position EN of the sheet S is not larger than the conveying distance D1 from the nip portion NP to the cutter 7 (L1≤D1) (S3, No), the controller CU causes the flapper 87 to locate at the second position and guides the sheet S to the second conveying path 82 (S8).

After step S8, the controller CU determines whether the predetermined time has elapsed from the reception of the detection signal of the third sensor SE3 (S9).

When not determining in step S9 that the predetermined time has elapsed from the reception of the detection signal of the third sensor SE3 (S9, No), the controller CU waits until the predetermined time elapses from the reception of the detection signal of the third sensor SE3. When the predetermined time elapses from the reception of the detection signal of the third sensor SE3, the leading end of the sheet S comes into contact with the switchback roller 86 and the skew is corrected.

When determining that the predetermined time has elapsed from the reception of the detection signal of the third sensor SE3 (S9, Yes), the controller CU drives the conveying motor M2 to rotate in the forward direction. As a result, the switchback roller 86 is caused to rotate in the forward direction and convey the sheet S to the cutter 7 (S10).

After step S10, when the expected cutting point PP of the sheet S reaches the cutter 7 after a predetermined time has elapsed from the start of the rotation of the conveying motor M2 in the forward direction, the conveying motor M2 is temporarily stopped and the cutting motor M1 is rotated in the forward direction (S11).

After step S11, the controller CU determines whether there is a job for the next sheet S (S12), and when determining that there is a job for the next sheet S (S12, Yes), the controller CU starts to feed the next sheet S (S13) and the process proceeds to S14. When not determining that there is a job for the next sheet S (S12, No), the process proceeds to S14 without feeding the next sheet S.

After step S12 or step S13, the controller CU stops the cutting motor M1 and causes the conveying motor M2 to rotate in the forward direction after a predetermined time has elapsed from the start of the cutting (S14). As a result, the slide holder 76 of the cutter 7 stops at the cutting completion position, and the sheet S is discharged by the second discharge roller 85.

After step S14, the controller CU stops the conveying motor M2 and causes the cutting motor M1 to rotate in the reverse direction (S15). As a result, the slide holder 76 of the cutter 7 returns to the initial position.

The controller CU determines whether the received job ends (S7) after step S15, the controller CU ends the process when the received job ends (S7, Yes), and returns to step S2 when the received job does not end (S7, No).

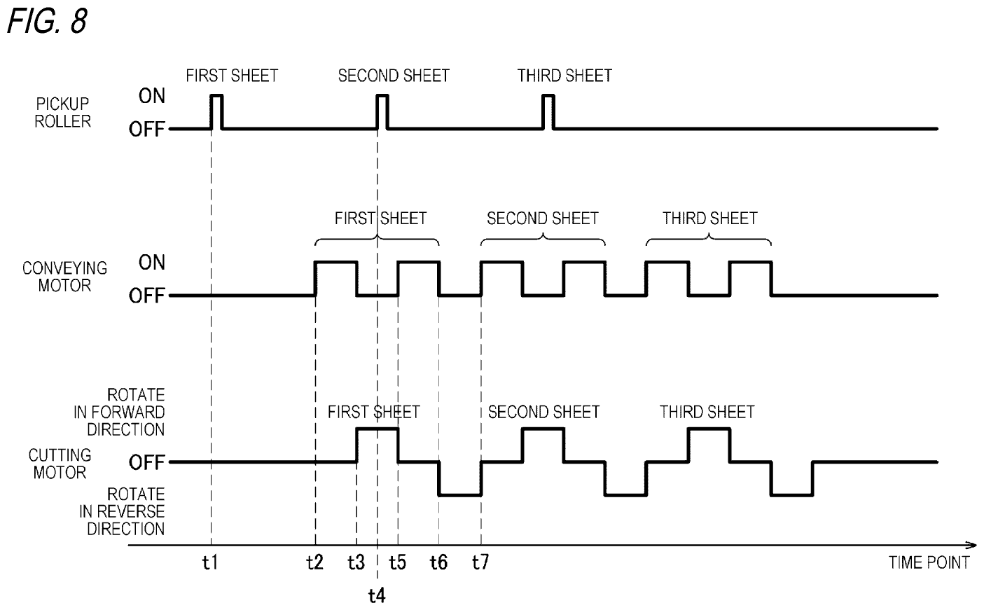

Next, an operation of picking up the sheets S, an operation of conveying the sheets S by the conveying motor M2 (the switchback roller 86 and the second discharge roller 85), and an operation of cutting the sheets S by the cutting motor M1 when a job to cut the plurality of sheets S is received will be described with reference to FIG. 8.

The controller CU drives the pickup roller 33 and starts to feed the first sheet S (at a time point t1). The fed first sheet S is subjected to the image formation and is conveyed toward the cutter 7.

After the predetermined time has elapsed from the reception of the detection signal of the third sensor SE3, the controller CU causes the conveying motor M2 to rotate in the forward direction and conveys the sheet S to the cutter 7 (at a time point t2).

After the predetermined time has elapsed from the start of the rotation of the conveying motor M2 in the forward direction, the controller CU temporarily stops the conveying motor M2 and causes the cutting motor M1 to rotate in the forward direction (at a time point t3). As a result, the cutting is started in a state in which the sheet S stops.

After the cutting motor M1 is rotated in the forward direction and before the cutting of the sheet S is completed, the controller CU drives the pickup roller 33 and starts to feed the second sheet S (at a time point t4). In this way, the conveyance of the second sheet S is started during the cutting of the first sheet S.

After the predetermined time has elapsed from the start of the cutting, the controller CU stops the cutting motor M1 and causes the conveying motor M2 to rotate in the forward direction (at a time point t5). As a result, the cut portions of the first sheet S are discharged.

After a predetermined time has elapsed from the time point t5, the controller CU stops the conveying motor M2 and causes the cutting motor M1 to rotate in the reverse direction (at a time point t6). As a result, the slide holder 76 of the cutter 7 starts to move from the cutting completion position toward the initial position.

When the slide holder 76 returns to the initial position after a predetermined time has elapsed from the time point t6, the controller CU stops the cutting motor M1 (at a time point t7). At this time, when a predetermined time has elapsed from the reception of the detection signal for the second sheet S from the third sensor SE3, the conveying motor M2 is rotated in the forward direction at the same time, and when the predetermined time does not elapse, the conveying motor M2 waits until the predetermined time has elapsed and then is rotated in the forward direction.

Regarding the second and third sheets S, the controller CU also performs the conveying operation and the cutting operation at the same timing as the first sheet S.

From the above, the following effects can be achieved according to the present embodiment.

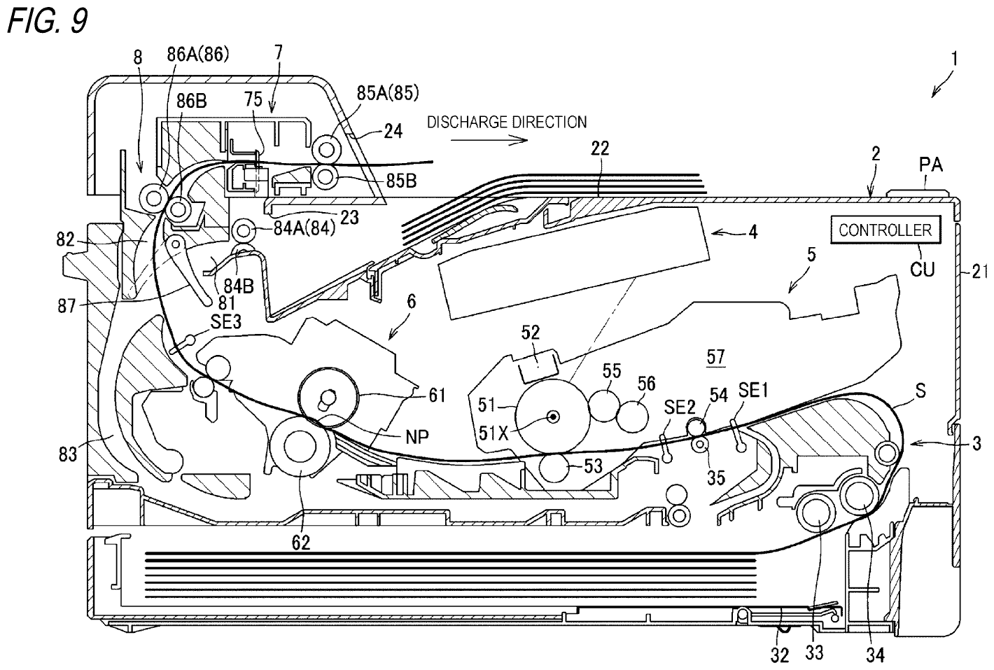

In the image forming apparatus 1, the second discharge roller 85 is located downstream of the first discharge roller 84 in the discharge direction. Therefore, as shown in FIG. 9, the cut sheet S is discharged downstream of the uncut sheet S in the discharge direction. Accordingly, the cut sheet S is easily taken.

Further, the second discharge port 24 is located downstream of the first discharge port 23 in the discharge direction. Therefore, the cut sheet is discharged downstream of the uncut sheet S in the discharge direction. Accordingly, the cut sheet S is easily taken.

In addition, the image forming apparatus 1 includes the flapper 87 that can move to the first position at which the sheet S having passed through the fixing unit 6 is guided to the first conveying path 81 and the second position at which the sheet S having passed through the fixing unit 6 is guided to the second conveying path 82. Therefore, the sheet S can be guided to either the first conveying path 81 or the second conveying path 82 by the flapper 87.

Here, since the cutter 7 cuts the sheet S in a state in which the trailing end of the sheet S has passed through the fixing unit 6, the cutter 7 is located at a predetermined distance or more from the fixing unit 6. Therefore, when the first discharge roller 84 is located farther from the fixing unit 6 than the second discharge roller 85 that discharges the cut sheet S, the size of the apparatus main body increases. However, in the present embodiment, the first discharge roller 84 is located closer to the fixing unit 6 than the second discharge roller 85, and thus it is possible to restrain the increase in size of the apparatus main body 2. Similarly, the first discharge port 23 is located closer to the fixing unit 6 than the second discharge port 24, and thus it is possible to reduce the size of the apparatus main body 2.

Further, the dimensions W1 and W2 of the second discharge roller 85 in the axial direction and the dimensions W3 and W4 of the switchback roller 86 in the axial direction are larger than the half WS/2 of the width of the sheet S having the maximum width and capable of being conveyed by the image forming apparatus 1 (W1>WS/2, W2>WS/2, W3>WS/2, and W4>WS/2). Therefore, at the time of cutting the sheet S, the second discharge roller 85 and the switchback roller 86 hold the sheet S in a wide region in the width direction, so that it is possible to restrain positional deviation of the sheet S at the time of cutting.

Further, at least one of the dimension W1 of the second discharge roller 85 in the axial direction and the dimension W3 of the switchback roller 86 in the axial direction is larger than the width WS of the sheet S having the maximum width and capable of being conveyed by the image forming apparatus 1. Therefore, at the time of cutting the sheet S, the second discharge roller 85 or the switchback roller 86 hold the sheet S in the wide region in the width direction, so that it is possible to restrain the positional deviation of the sheet S at the time of cutting.

Further, when acquiring the dimension of the sheet S in the conveying direction and determining that the dimension of the sheet S in the conveying direction is smaller than the predetermined value (139.7 mm) based on the detection signal from the sensor SE or the information on the job, the controller CU conveys the sheet S to the second conveying path 82 and discharges the sheet S to the outside of the apparatus main body 2 without cutting the sheet S. Therefore, when the small-sized sheet S is discharged, the sheet S is discharged through the second conveying path 82, and thus the small-sized sheet S is easily taken.

In addition, as shown in FIG. 4, the conveying distance D1 by which the sheet S is conveyed from the nip portion NP to the cutter 7 is larger than half of the dimension LS (279.4 mm) of the sheet S having the letter size in the conveying direction (D1>LS/2=139.7 mm). Therefore, the sheet S can be cut in a state in which the entire sheet S having the letter size has passed through the nip portion NP. Accordingly, even when the sheet S is cut in the state in which the conveyance of the sheet S stops, it is possible to restrain the sheet S from being heated and pressurized more than necessary at the nip portion NP.

Further, when the command to cut the sheet S is received, the controller CU cuts the sheet S in the state in which the conveyance of the sheet S stops. Therefore, the sheet S can be cut straight in the axial direction.

Further, when the command to cut the sheet S is received, the controller CU cuts the sheet S by the cutter 7 in the case in which the dimension L1 in the conveying direction from the expected cutting point PP of the sheet S to the trailing end position EN of the sheet S is smaller than the conveying distance D1 of the sheet from the nip portion NP to the cutter 7. Accordingly, the controller CU does not cut the sheet S by the cutter 7 in the case in which the dimension L1 in the conveying direction from the expected cutting point PP of the sheet S to the trailing end position EN of the sheet S is equal to or larger than the conveying distance D1 of the sheet S from the nip portion NP to the cutter 7, and thus it is possible to restrain the sheet S from being heated and pressurized more than necessary at the nip portion NP.

Further, when the sheet S is conveyed to the cutter 7, the controller CU starts to rotate the switchback roller 86 after the leading end of the sheet S in the conveying direction comes into contact with the switchback roller 86. Therefore, even when the sheet S is conveyed in a skewed manner with respect to the conveying direction, it is possible to restrain the skew by bringing the sheet S into contact with the switchback roller 86.

The conveying speed by the second discharge roller 85 is higher than the conveying speed by the switchback roller 86. Therefore, when the sheet S is in contact with both the second discharge roller 85 and the switchback roller 86, the sheet S is pulled by the second discharge roller 85 and the switchback roller 86, and thus it is possible to restrain the slackness of the sheet S between the switchback roller 86 and the second discharge roller 85. Further, after the sheet S is cut, it is possible to restrain the cut sheets S from coming into contact with each other and restrain the sheets from interfering with each other.

In addition, when the command to cut a plurality of sheets S is received, the controller CU starts to feed the next sheet S before the cutting of the preceding sheet S is completed. Therefore, even when the plurality of sheets are cut, it is possible to restrain the completion of the work from being delayed.

Further, when the command to cut a plurality of sheets S is received, the controller CU conveys the sheets S at the predetermined interval between the trailing end of the preceding sheet S and the leading end of the next sheet S. Therefore, it is possible to restrain the interference between the preceding sheet S and the next sheet S.

Although the embodiment according to the present disclosure has been described above, the present disclosure is not limited to the embodiment. The specific configuration can be appropriately changed without departing from the gist of the present disclosure.

In the above embodiment, the sheets S discharged from the first discharge port 23 and the second discharge port 24 are placed on one discharge tray 22, but the present disclosure is not limited to this configuration.

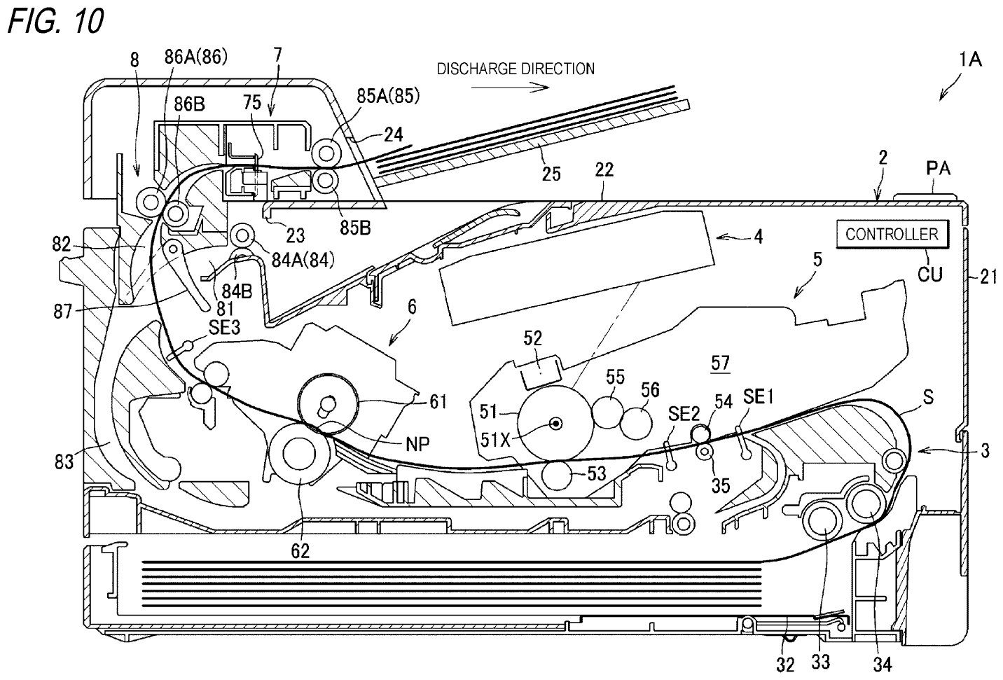

For example, an image forming apparatus 1A shown in FIG. 10 includes the discharge tray 22 as an example of a first discharge tray and a second discharge tray 25. The sheet S discharged through the first conveying path 81 can be stacked on the discharge tray 22. The sheet S discharged through the second conveying path 82 can be stacked on the second discharge tray 25. The second discharge tray 25 is provided outside the second discharge port 24. Therefore, in the image forming apparatus 1A, the sheet S discharged from the first conveying path 81 and the sheet S discharged from the second conveying path 82 can be housed in different trays. Accordingly, the cut sheet S is easily taken.

Although in the above embodiment, the sheets S discharged from the first discharge port 23 and the second discharge port 24 are placed on the discharge tray 22, a configuration not including a discharge tray may be adopted. Although not shown, for example, the sheets S discharged from the first discharge port 23 and the second discharge port 24 may be directly discharged onto a desk, a floor, or the like, and the sheets S may be placed on the desk, the floor, or the like.

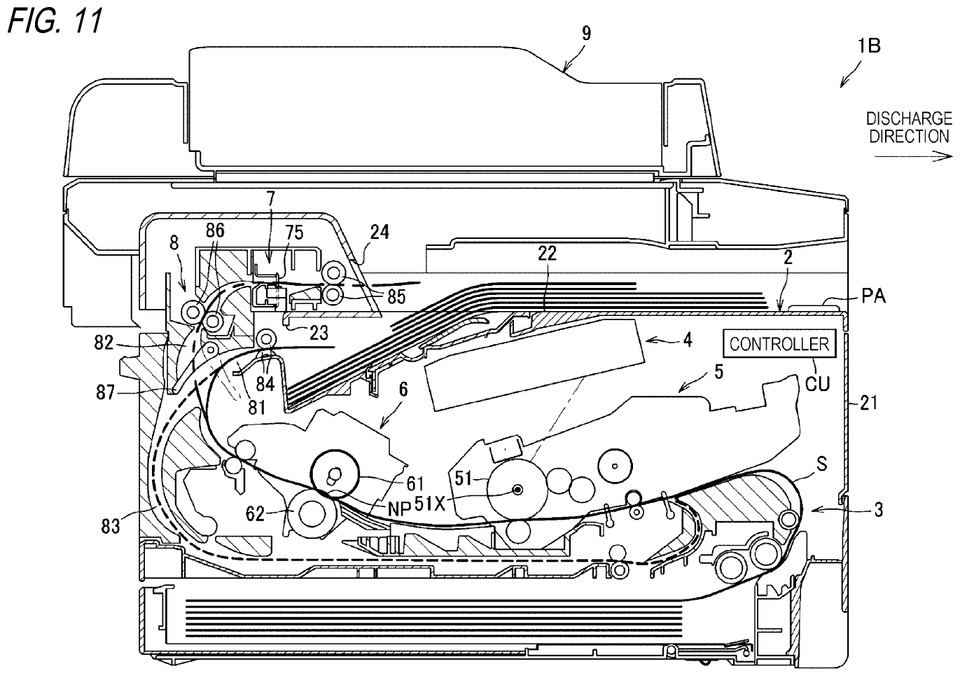

In the above embodiment, the image forming apparatus 1 does not include a scanner unit, but the present disclosure is not limited to this configuration. For example, an image forming apparatus 1B shown in FIG. 11 further includes a scanner unit 9. The scanner unit 9 is a device for reading a character or an image on the sheet S or the like. In the image forming apparatus 1B, the scanner unit 9 is disposed above the discharge tray 22, and thus a gap for taking out the sheet S is narrow, and if the cut sheet S is discharged to the same position as the uncut sheet S, it is very difficult to take the sheet S. However, since the second discharge roller 85 is located downstream of the first discharge roller 84 in the discharge direction and the second discharge port 24 is located downstream of the first discharge port 23 in the discharge direction, the cut sheet S is discharged downstream of the uncut sheet S in the conveying direction, thereby making it easier to take the cut sheet S.

Although in the above embodiment, the conveying distance D1 by which the sheet S is conveyed from the nip portion NP to the cutter 7 is larger than the half (139.7 mm) of the dimension LS of the sheet S having the letter size in the conveying direction, the sheet S having a size other than the letter size may be a reference.

For example, with reference to A4 size (210 mm×297 mm), the conveying distance D1 by which the sheet S is conveyed from the nip portion NP to the cutter 7 may be larger than the half (148.5 mm) of the dimension LS of the sheet S having the A4 size in the conveying direction.

Accordingly, the sheet S can be cut in a state in which the entire sheet S having the A4 size has passed through the nip portion NP. Accordingly, even when the sheet S is cut in the state in which the conveyance of the sheet S stops, it is possible to restrain the sheet S from being heated and pressurized more than necessary at the nip portion NP.

For example, with reference to legal size (215.9 mm×355.6 mm), the conveying distance D1 by which the sheet S is conveyed from the nip portion NP to the cutter 7 may be larger than the half (177.8 mm) of the dimension LS of the sheet S having the legal size in the conveying direction.

Accordingly, the sheet S can be cut in a state in which the entire sheet S having the legal size has passed through the nip portion NP. Therefore, even when the sheet S is cut in the state in which the conveyance of the sheet S stops, it is possible to restrain the sheet S from being heated and pressurized more than necessary at the nip portion NP.

In the above embodiment, after the cutter 7 cuts one sheet S into two portions, the two portions are discharged immediately after the cutting, but the present disclosure is not limited to this configuration.

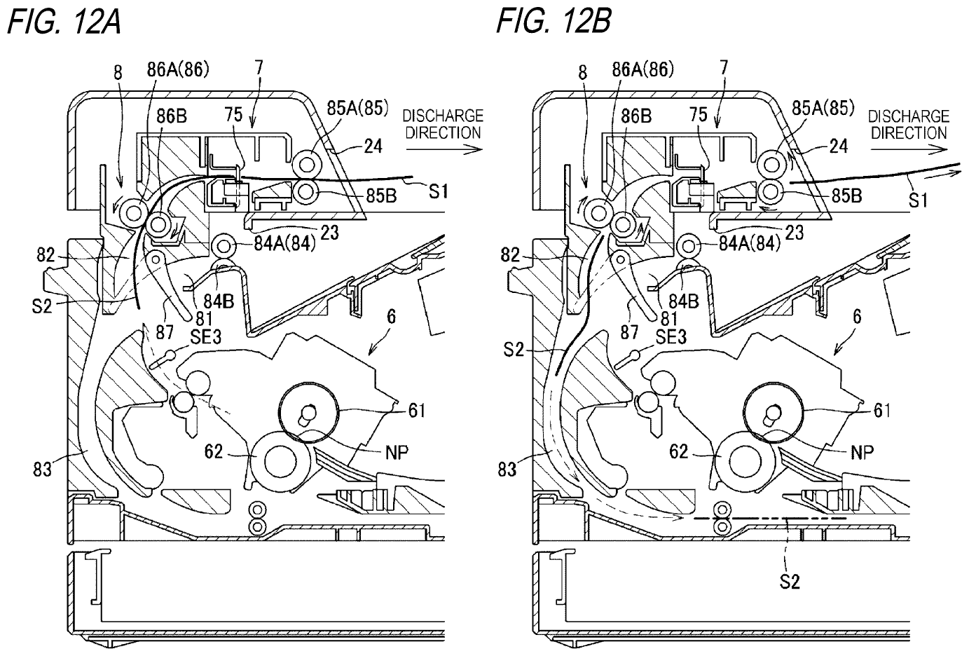

For example, as shown in FIGS. 12A and 12B, the controller CU may cause the cutter 7 to cut one sheet S into two portions (S1 and S2) and rotate the switchback roller 86 in the reverse direction so as to convey the sheet S2 on the upstream side in the conveying direction of the cut sheets S to the re-conveying path 83.

Specifically, as shown in FIG. 12A, the controller CU causes the cutter 7 to cut one sheet S into two portions (S1 and S2). As shown in FIG. 12B, the sheet S1 on the downstream side of the cut sheets S is discharged from the second discharge port 24 after the cutting. Of the cut sheets S, the sheet S2 on the upstream side is conveyed to the re-conveying path 83. Then, the sheet S2 on the upstream side is kept in the re-conveying path 83 as indicated by a two-dot chain line in FIG. 12B. When receiving a job corresponding to the sheet S2, the controller CU conveys the kept sheet S2 to the image forming unit and executes the image formation. When determining that the received job cannot be executed while the sheet S2 is kept in the re-conveying path 83, the controller CU discharges the sheet S2 without executing the image formation. As described above, in the embodiment shown in FIGS. 12A and 12B, the sheet S2 on the upstream side of the cut sheets S can be re-conveyed to the re-conveying path 83 and can be subjected to the image formation again.

In the above embodiment, the controller CU does not cut the sheet S when the dimension in the conveying direction from the expected cutting point PP of the sheet S to a trailing end position EN of the sheet is larger than the conveying distance D1 of the sheet S from the position of the nip portion NP to the cutter 7, but the present disclosure is not limited to this configuration.

For example, the controller CU may cut the sheet S even when the dimension in the conveying direction from the expected cutting point PP of the sheet S to the trailing end position EN of the sheet S is larger than the conveying distance D1 of the sheet S from the position of the nip portion NP to the cutter 7.

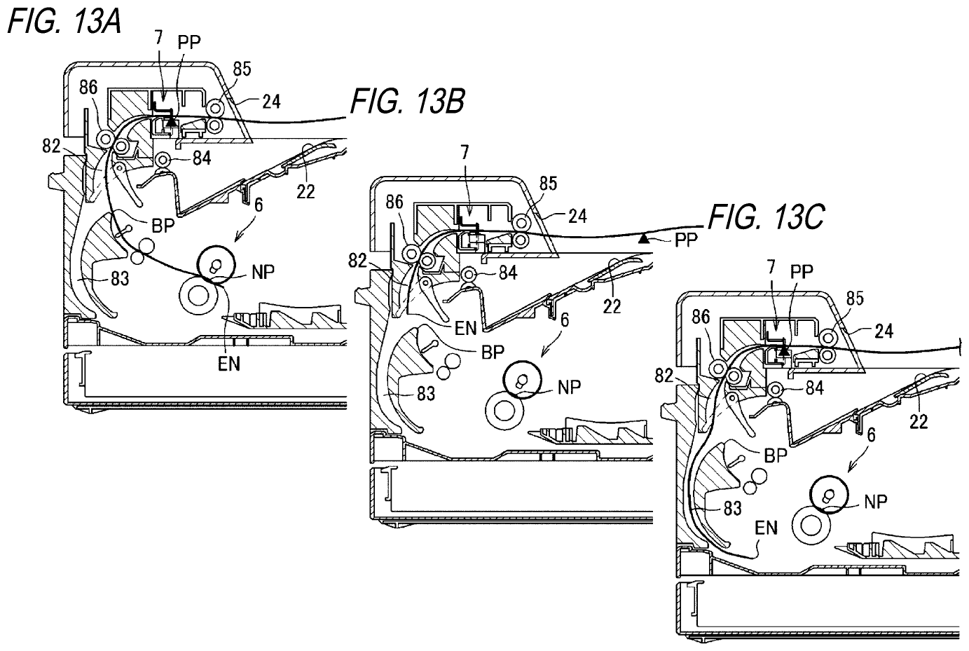

As shown in FIG. 13A, the controller CU executes a trailing end avoiding control when the dimension from the expected cutting point PP to the trailing end position EN of the sheet S is larger than the conveying distance D1. In FIGS. 13A to 13C, the expected cutting point PP is indicated by a black triangle.

In the trailing end avoiding control, as shown in FIG. 13B, the sheet S is conveyed until the expected cutting point PP of the sheet S is located downstream of the cutter 7 and a trailing end EN is located downstream of the path from the fixing unit 6 to the flapper 87 and a branch point BP of the re-conveying path. Then, as shown in FIG. 13C, the trailing end position EN of the sheet S enters the re-conveying path 83 by rotating the switchback roller 86 in the reverse direction, and the sheet S is cut in a state in which the trailing end position EN of the sheet S enters the re-conveying path.

Accordingly, even when the conveying distance D1 is smaller than the dimension from the expected cutting point PP of the sheet to the trailing end position EN of the sheet, the sheet S can be cut in a state in which the trailing end position EN of the sheet S has passed through the fixing unit 6. Therefore, when the cutter 7 cuts the expected cutting point PP of the sheet S, it is possible to restrain the sheet S from being sandwiched between the heating unit 61 and the pressure roller 62. As a result, it is possible to restrain an increase in the size of the image forming apparatus 1.

In the above embodiment, when the command to cut a plurality of sheets S is received, the controller CU starts to feed the next sheet S before the cutting of the preceding sheet S is completed, but the present disclosure is not limited to this configuration.

For example, when the command to cut a plurality of sheets S is received, the controller CU may move the moving blade 75 from the initial position in the width direction of the sheet S to cut the sheet S, and start to feed the next sheet S after the cutting of the preceding sheet S is completed and before the moving blade 75 reaches the initial position.

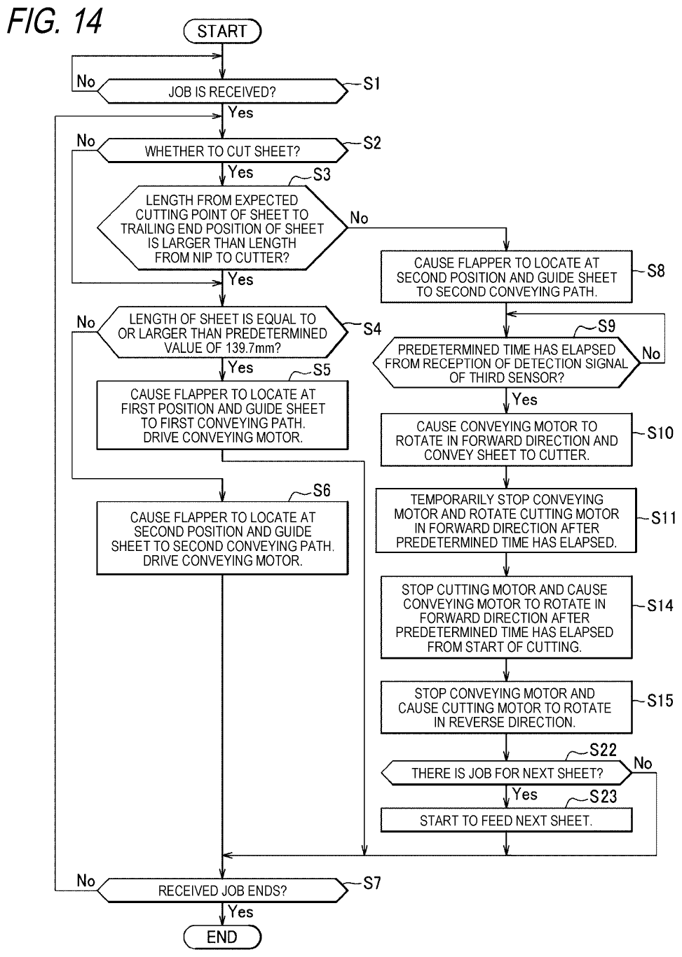

Specifically, as shown in FIG. 14, when there is a job for the next sheet S (S22, Yes) after the cutting motor M1 is rotated in the reverse direction in step S15, the controller CU starts to feed the next sheet S (S23). Then, when the slide holder 76 of the cutter 7 returns to the initial position after step S23, the controller CU stops the cutting motor M1.

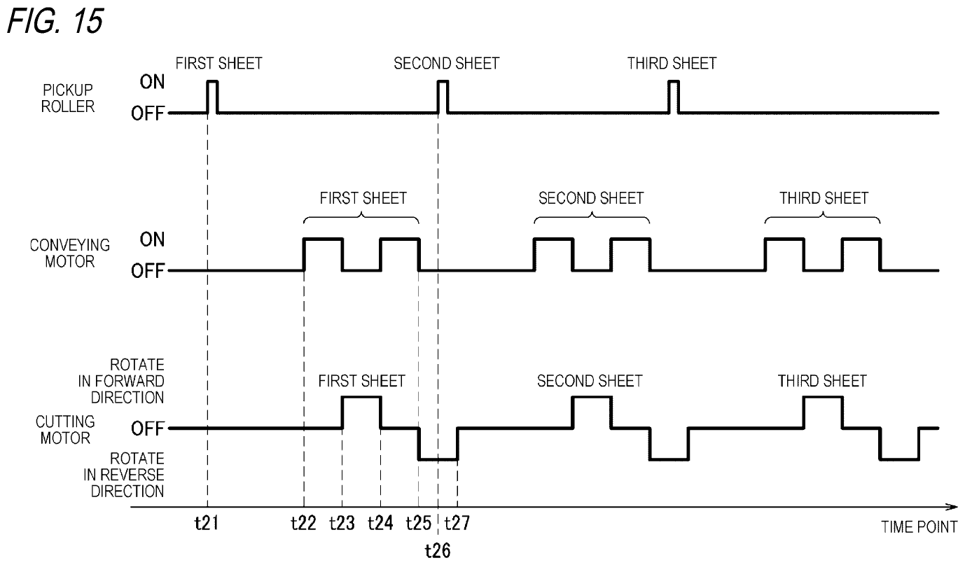

In this case, the operation of picking up the sheets S, the operation of conveying the sheets S by the conveying motor M2 (the switchback roller 86 and the second discharge roller 85), and the operation of cutting the sheets S by the cutting motor M1 when the job to cut the plurality of sheets S is received will be described with reference to FIG. 15.

The controller CU drives the pickup roller 33 and starts to feed the first sheet S (at a time point t21). The fed first sheet S is subjected to the image formation and is conveyed toward the cutter 7.

After the predetermined time has elapsed from the reception of the detection signal of the third sensor SE3, the controller CU causes the conveying motor M2 to rotate in the forward direction and conveys the sheet S to the cutter 7 (at a time point t22).

After the predetermined time has elapsed from the start of the rotation of the conveying motor M2 in the forward direction, the controller CU temporarily stops the conveying motor M2 and causes the cutting motor M1 to rotate in the forward direction (at a time point t23). As a result, the cutting is started in the state in which the sheet S stops.

After the predetermined time has elapsed from the start of the cutting, the controller CU stops the cutting motor M1 and causes the conveying motor M2 to rotate in the forward direction (at a time point t24). As a result, the cut portions of the first sheet S are discharged.

After a predetermined time has elapsed from the time point t24, the controller CU stops the conveying motor M2 and causes the cutting motor M1 to rotate in the reverse direction (at a time point t25). As a result, the moving blade 75 of the cutter 7 starts to move from the cutting completion position toward the initial position.

After the cutting motor M1 is rotated in the reverse direction and before the moving blade 75 reaches the initial position, the controller CU drives the pickup roller 33 and starts to feed the second sheet S (at a time point t26). In this way, the conveyance of the second sheet S is started during the movement of the moving blade 75.

When the slide holder 76 returns to the initial position after a predetermined time has elapsed from the time point t25, the controller CU stops the cutting motor M1 (at a time point t27).

Regarding the second and third sheets S, the controller CU also performs the conveying operation and the cutting operation at the same timing as the first sheet S.

Even in the above configuration, the conveyance of the next sheet S is started before the moving blade 75 reaches the initial position, and thus it is possible to restrain the completion of the work from being delayed even in the case of cutting the plurality of sheets S.

In the above embodiment, the cutter 7 is disposed in the second conveying path 82, but the present disclosure is not limited to this configuration. For example, the cutter 7 may be disposed between the flapper 87 and the fixing unit 6.

In the above embodiment, the operation panel PA is exemplified as the input unit, but a print command or a cutting command may be input via a computer or a network.

In the above embodiment, each of the first discharge roller 84, the second discharge roller 85, and the switchback roller 86 is a roller pair including two rollers, but the present disclosure is not limited thereto, and each of the first discharge roller 84, the second discharge roller 85, and the switchback roller 86 may be implemented by one roller, or may include three or more rollers.

In the above embodiment, the maximum width by which the sheet S can be conveyed by the image forming apparatus 1 is set to 215.9 mm by using the letter size (215.9 mm×279.4 mm) as an example, but the present disclosure is not limited to this dimension, the A4 size (210 mm×297 mm) and A3 size (297 mm×420 mm) may be used as a reference.

In the above embodiment, the image forming apparatus is a laser printer that forms a monochrome image, but the present disclosure is not limited thereto. For example, the image forming apparatus may be a printer that forms a color image. Further, the image forming apparatus is not limited to the printer. For example, the image forming apparatus may be a copier, a multi function device, and the like.

### Embodiment 2

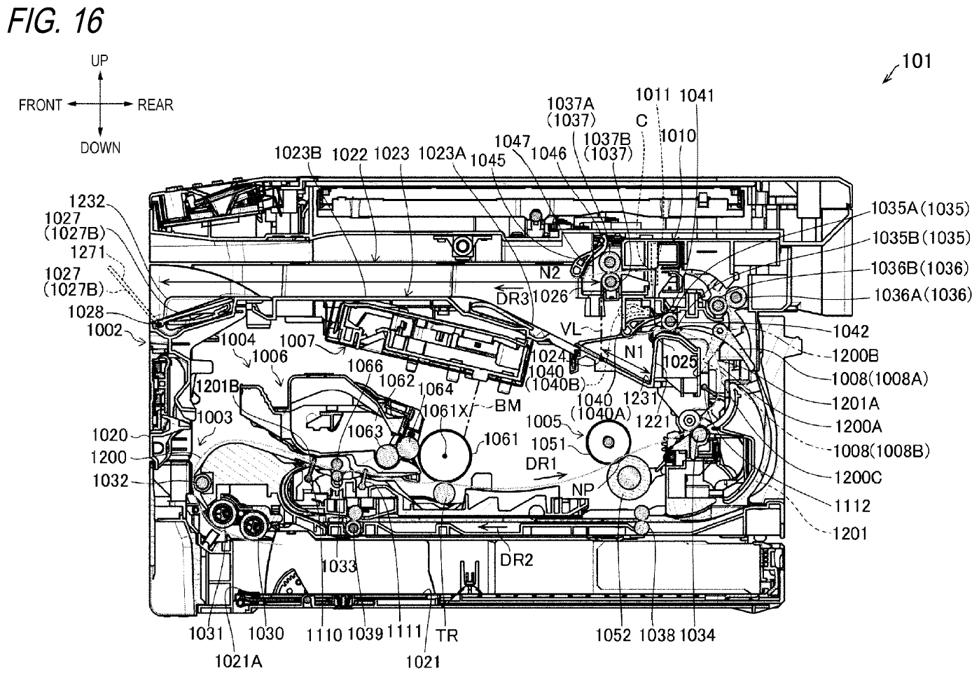

Hereinafter, an image forming apparatus 101 according to Embodiment 2 of the present disclosure will be described in detail with reference to FIGS. 16 to 19. FIG. 16 is a diagram showing a schematic configuration of the image forming apparatus 101 according to Embodiment 2 of the present disclosure.

### Configuration of Image Forming Apparatus

As shown in FIG. 1, the image forming apparatus 101 is a monochrome laser printer, and includes an apparatus main body 102, a conveying unit 103, an image forming unit 104, a flapper 108, a cutter 1010, a pre-registration sensor 1110, a post-registration sensor 1111, and a discharge sensor 1112. Hereinafter, for convenience of description, as shown by arrows in FIG. 16 and the like, an up-down direction, a front-rear direction, and a left-right direction of the image forming apparatus 101 are defined.

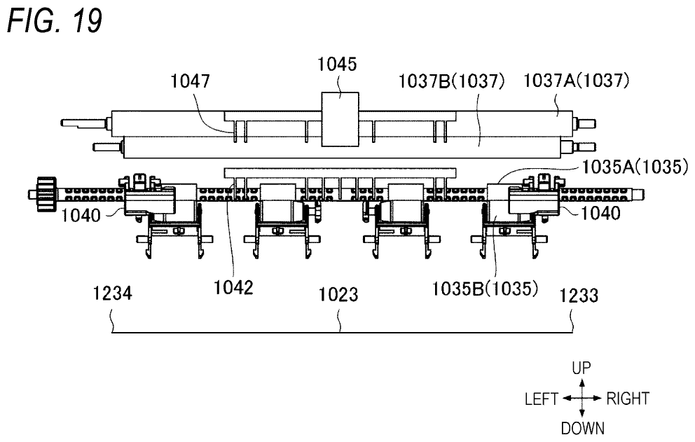

The up-down direction shown in FIG. 16 and the like refers to an up-down direction in use of the normal image forming apparatus 101 in a case in which the image forming apparatus 101 is placed on a horizontal plane. In the present embodiment, the front-rear direction shown in FIG. 16 and the like is the same direction as a discharge direction DR3 of the sheet S, and the left-right direction shown in FIG. 19 is a width direction of a placement surface 1023 of a discharge tray 1022. The width direction also corresponds to the axial direction of the rollers.

The apparatus main body 102 includes a front cover 1020, a feed tray 1021, the discharge tray 1022, a first discharge port 1025, and a second discharge port 1026. The front cover 1020 is located on a front surface of the apparatus main body 102. The front cover 1020 is openable and closable.

The feed tray 1021 is located at a lower portion of the apparatus main body 102. The sheet S is placed on the feed tray 1021. The sheet S refers to, for example, plain paper, thick paper, glossy paper, label paper, or an envelope. The number of feed trays 1021 of the image forming apparatus 1 is not limited to one, and a plurality of feed trays 1021 may be provided.

The feed tray 1021 can be pulled out from the apparatus main body 102 by moving forward, and can be attached to the apparatus main body 102 by moving backward after being pulled out. In a state in which the feed tray 1021 is removed from the apparatus main body 102, for example, it is possible for the user to replenish the feed tray 1021 with the sheet S and to replace the sheet S placed on the feed tray 1021. Among the sheets placed on the feed tray 1021, the sheet having the A4 size are placed such that long sides thereof are along the front-rear direction. That is, the sheet having the A4 size is conveyed such that the long sides thereof are along the conveying direction. The size of the sheet is an example, and is not limited to the A4 size.

The feed tray 1021 includes a sheet pressing plate 1021A. The sheet pressing plate 1021A pushes upward the sheet S in the feed tray 1021. When the sheet S is pushed upward by the sheet pressing plate 1021A, the sheet S can be conveyed from the feed tray 1021 to the image forming unit 104.

The discharge tray 1022 is provided in the apparatus main body 102 and is located outside the apparatus main body 102. More specifically, the discharge tray 1022 constitutes a part of an upper surface of the apparatus main body. The discharge tray 1022 includes the placement surface 1023, a stopper 1027, and a standing wall 1221.

The placement surface 1023 is a surface on which the sheets S discharged by a first discharge roller 1035 and a second discharge roller 1037, which are described later, are placed. The placement surface 1023 includes an inclined surface 1023A and a horizontal surface 1023B. The inclined surface 1023A is formed between a first end 1231 of the placement surface 1023 and a second end 1232 of the placement surface 1023 such that the first end 1231 is located below the second end 1232. The first end 1231 is located on a first discharge roller 1035 side in the discharge direction DR3, and the second end 1232 is located on a side opposite to the first end 1231 in the discharge direction DR3. The inclined surface 1023A is a surface that is inclined upward from the first end 1231 toward a second end 1232 side, that is, from the rear toward the front in the present embodiment.

The horizontal surface 1023B is formed on the second end 1232 side with respect to the inclined surface 1023A in the discharge direction DR3. The horizontal surface 1023B is a horizontal surface continuing from the second end 1232 side of the inclined surface 1023A to the second end 1232. The horizontal surface 1023B is located below the second discharge roller 1037 to be described later. Further, a horizontal surface may be formed between the first end 1231 and the inclined surface 1023A. That is, the placement surface 1023 may be formed continuously with the horizontal surface, the inclined surface 1023A, and the horizontal surface 1023B in order from the first end 1231 toward the discharge direction DR3.

The stopper 1027 is provided on the second end 1232 side of the placement surface 1023 of the discharge tray 1022. The stopper 1027 comes into contact with the sheet S discharged to the discharge tray 1022 to stack the sheet S discharged to the discharge tray 1022 in the discharge tray 1022.

The stopper 1027 is pivotable about a pivot shaft 1028 between a housed position 1027A and a use position 1027B. The housed position 1027A refers to a state in which the stopper 1027 is housed in a recess of the discharge tray 1022. Therefore, when the stopper 1027 is located at the housed position 1027A, the sheet S moving to the front of the apparatus main body 102, for example, the sheet S discharged in the discharge direction DR3 does not come into contact with a contact surface 1271 of the stopper 1027. That is, when the stopper 1027 is located at the housed position 1027A, the forward movement of the sheet S is not limited by the stopper 1027.

The use position 1027B of the stopper 1027 is a position in a state in which the stopper 1027 pivots to the outside from the recess of the discharge tray 1022. When the stopper 1027 is located at the use position 1027B, the stopper 1027 protrudes upward from the placement surface 1023. Therefore, the contact surface 1271 of the stopper 1027 and the sheet S moving to the front of the apparatus main body 102, for example, the discharged sheet S moving in the discharge direction DR3, can come into contact with each other. As a result, the forward movement of the sheet S can be limited by the stopper 1027, and the sheet S can be housed in the discharge tray 1022.

The standing wall 1221 is a wall protruding upward from the first end 1231 of the placement surface 1023. The standing wall 1221 is located below the first discharge port 1025 formed in the apparatus main body 102. The standing wall 1221 can come into contact with a rear end portion of the sheet S moving downward along the inclined surface 1023A. Therefore, the rear end portion of the discharged sheet S can be aligned.

The apparatus main body 102 includes a conveying path 1200 and a re-conveying path 1201. The conveying path 1200 is a path for conveying the sheet S from the feed tray 1021 toward the outside of the apparatus main body 102 through the image forming unit 104 and a fixing device (fixing unit) 105, which are described later. The re-conveying path 1201 will be described later.

The conveying path 1200 includes a first conveying path 1200A and a second conveying path 1200B. The conveying path 1200 branches into the first conveying path 1200A and the second conveying path 1200B from a branch point 1200C.

The first conveying path 1200A is a part of the conveying path 1200 and is located downstream of the branch point 1200C. The first conveying path 1200A is a path from the branch point 1200C to the first discharge port 1025 for discharging the sheet S to the outside of the apparatus main body 102. The first conveying path 1200A is a path for guiding the sheet S on which the image is formed to the first discharge roller 1035.

The second conveying path 1200B is a part of the conveying path 1200 and is located downstream of the branch point 1200C. The second conveying path 1200B is located above the first conveying path. The second conveying path 1200B is a path from the branch point 1200C to the second discharge port 1026 for discharging the sheet S toward the outside of the apparatus main body 102. The second conveying path 1200B is a path for guiding the sheet S on which the image is formed to the second discharge roller 1037.

In the vicinity of the branch point 1200C, the flapper 108 for distributing the sheet S to the first conveying path 1200A or the second conveying path 1200B is provided. The flapper 108 can pivot between a first position 108A indicated by a solid line and a second position 108B indicated by a two-dot chain line by a drive force of a drive motor (not shown).

When the flapper 108 is located at the first position 108A, the sheet S is conveyed in a first conveying direction DR1 of the first conveying path 1200A and is guided to the first discharge port 1025. On the other hand, when the flapper 108 is located at the second position 108B, the sheet S is guided to the second discharge port 1026 along the first conveying direction DR1 of the second conveying path 1200B.

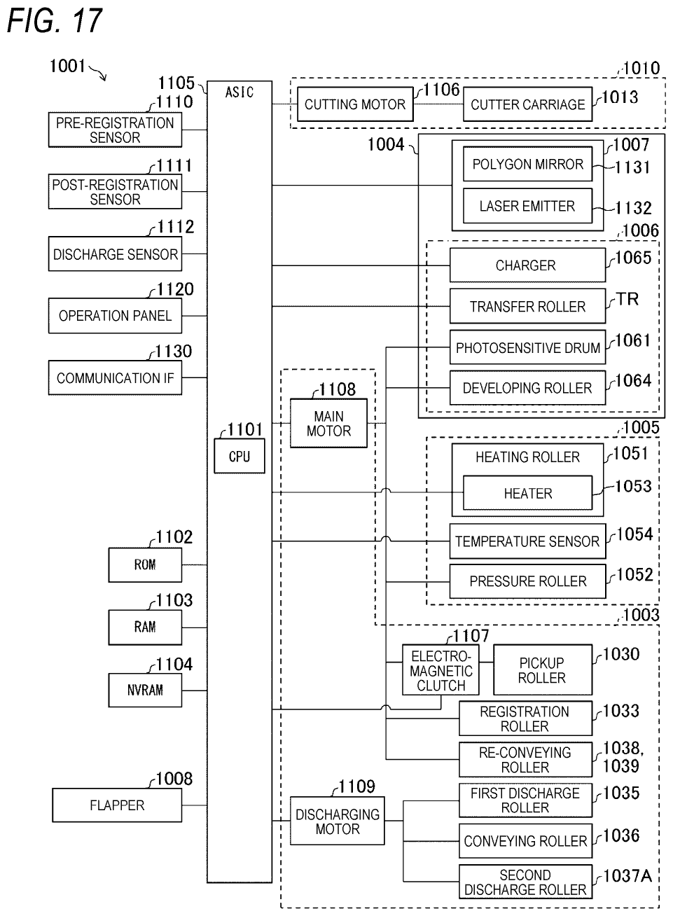

The conveying unit 103 includes a pickup roller 1030, a separation roller 1031, a paper dust removing roller 1032, a registration roller 1033, a roller 1034, the first discharge roller 1035, a conveying roller 1036, the second discharge roller 1037, and re-conveying rollers 1038 and 1039. Further, the conveying unit 103 further includes a main motor 1108 and a discharging motor 1109 which are described later with reference to FIG. 17, and conveys the sheet S by using a drive force transmitted from the main motor 1108 or the discharging motor 1109 to rotate the respective parts of the conveying unit 103.

The pickup roller 1030 is rotated by the drive force transmitted from the main motor 1108 (FIG. 17). The pickup roller 1030 picks up the sheet S pushed upward by the sheet pressing plate 1021A in the feed tray 1021. The separation roller 1031 separates the sheet S picked up by the pickup roller 1030 one by one. The sheet S is conveyed from the feed tray 1021 to the conveying path 1200 by the pickup roller 1030 and the separation roller 1031, so that the sheet S is fed from the feed tray 1021 to the conveying path 1200. The paper dust removing roller 1032 removes paper dust and the like on a surface of the sheet S.

The registration roller 1033 is disposed upstream of the image forming unit 104 in the conveying path 1200. The registration roller 1033 aligns a direction of the leading end of the sheet S and then conveys the sheet S toward the image forming unit 104. The roller 1034 is disposed downstream of the fixing device 105 and conveys the sheet S having passed through the fixing device 105 toward the branch point 1200C.

The first discharge roller 1035 is disposed in the first conveying path 1200A. The first discharge roller 1035 is disposed upstream of the first end 1231 of the placement surface 1023 in the discharge direction DR3. The first discharge roller 1035 is rotated by the drive force transmitted from the discharging motor 1109 (FIG. 17) to discharge the sheet S from the first discharge port 1025 toward the outside of the apparatus main body 102 along the first conveying path 1200A. The sheet S discharged from the first discharge port 1025 by the first discharge roller 1035 is placed on the placement surface 1023 of the discharge tray 1022. The first discharge roller 1035 includes a drive roller 1035A that is driven by driving of the discharging motor 1109, and a driven roller 1035B that rotates in accordance with the rotation of the drive roller 1035A.

The conveying roller 1036 and the second discharge roller 1037 are disposed in the second conveying path 1200B. The conveying roller 1036 and the second discharge roller 1037 are rotated by the drive force transmitted from the discharging motor 1109 (FIG. 17). The conveying roller 1036 conveys the sheet S toward the second discharge roller 1037. The conveying roller 1036 is a conveying roller that is located at a position closest to the second discharge roller 1037 in the first conveying direction DR1. The conveying roller 1036 includes a drive roller 1036A that is driven by the driving of the discharging motor 1109, and a driven roller 1036B that rotates in accordance with the rotation of the drive roller 1036A.

The second discharge roller 1037 discharges the sheet S from the second discharge port 1026 toward the outside of the apparatus main body 102 along the second conveying path 1200B. The sheet S discharged from the second discharge port 1026 by the second discharge roller 1037 is placed on the placement surface 1023 of the discharge tray 1022. The second discharge roller 1037 is located downstream of the first discharge roller 1035 in the discharge direction DR3, that is, located in front of the apparatus main body. The second discharge roller 1037 is located above the first discharge roller 1035. The second discharge roller 1037 includes a drive roller 1037A that is driven by driving of the discharging motor 1109, and a driven roller 1037B that rotates in accordance with the rotation of the drive roller 1037A.

The image forming unit 104 includes a drum cartridge 106, a laser unit 107, and the fixing device 105, and forms an image on the sheet S. The drum cartridge 106 includes a photosensitive drum 1061, a toner containing portion 1062, a feed roller 1063, a developing roller 1064, a pinch roller 1066, and a transfer roller TR. The drum cartridge 106 is attachable to and detachable from the apparatus main body 102.

The pinch roller 1066 of the drum cartridge 106 is located to face the registration roller 1033. The pinch roller 1066 rotates following the rotation of the registration roller 1033 to convey the sheet S together with the registration roller 1033.

The photosensitive drum 1061 rotates about a drum shaft 1061X by the drive force transmitted from the main motor 1108 (FIG. 17).

The laser unit 107 emits a laser beam BM based on image data, and exposes a surface of the photosensitive drum 1061 whose surface is uniformly charged by a charger (not shown). An electrostatic latent image based on the image data is formed on the exposed surface of the photosensitive drum 1061.

The feed roller 1063 of the drum cartridge 106 feeds the toner in the toner containing portion 1062 to the developing roller 1064. The developing roller 1064 feeds the toner to the electrostatic latent image formed on the surface of the photosensitive drum 1061. As a result, the electrostatic latent image is visualized, and the toner image is formed on the surface of the photosensitive drum 1061.

The transfer roller TR of the drum cartridge 106 is located to face the photosensitive drum 1061. The transfer roller TR transfers the toner fed on the photosensitive drum 1061 to the sheet S. When the sheet S is conveyed between the photosensitive drum 1061 and the transfer roller TR, the toner image is transferred to the sheet S.

The fixing device 105 fixes the toner transferred to the sheet S onto the sheet S. The fixing device 105 includes a heating roller 1051, a pressure roller 1052, a heater 1053 (FIG. 17), and a temperature sensor 1054 (FIG. 17). The heater 1053 is, for example, a halogen heater, and heats the heating roller 1051. The heating roller 1051 is an example of the heating rotation body. The temperature sensor 1054 is, for example, a thermistor, and detects the temperature of the heating roller 1051. The temperature sensor 1054 may be a thermocouple or a resistance temperature detector.

The pressure roller 1052 forms a nip NP between the pressure roller 1052 and the heating roller 1051. The pressure roller 1052 is an example of the pressure rotation body. When the pressure roller 1052 is rotated by the drive force transmitted from the main motor 1108 (FIG. 17), the sheet S is conveyed to pass through the nip NP. The sheet S having passed through the nip portion NP is heated by the heating roller 1051, and the toner image is thermally fixed to the sheet S having passed through the nip NP. Instead of the pressure roller 1052, a nip forming member including a belt and a pad for pressurizing the belt between the pad and the pressure roller may be provided as the pressure rotation body.

The cutter 1010 includes a blade 1011 capable of cutting the sheet S. The cutter 1010 is an example of a cutting mechanism. The cutter 1010 is disposed in the second conveying path 1200B. The cutter 1010 cuts the sheet S by moving the blade 1011 in a cutting direction orthogonal to the first conveying direction DR1 of the second conveying path 1200B. In the present embodiment, the cutting direction orthogonal to the first conveying direction DR1 is a direction orthogonal to the front-rear direction, and is a direction parallel to a rotational center axis of the second discharge roller 1037. The cutting direction is not limited to the direction orthogonal to first conveying direction DR1, and may be any direction intersecting the first conveying direction DR1.

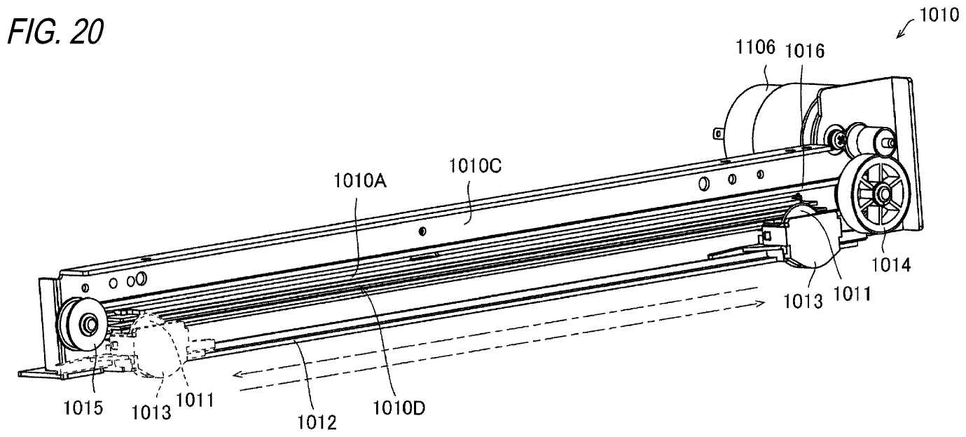

Here, a schematic configuration of the cutter 1010 will be described with reference to FIG. 20. FIG. 20 is a perspective view showing the schematic configuration of the cutter 1010. As shown in FIG. 20, the cutter 1010 includes a support guide 1010C, a slide rail 1012, a fixed blade 1010A, the blade 1011, a cutter carriage 1013, a cutting motor 1106, a drive pulley 1014, a driven pulley 1015, and a pulley belt 1016.

A support guide 10C extends in a sub-scanning direction as a direction orthogonal to the conveying direction of the sheet. In the present embodiment, the sub-scanning direction is the left-right direction, and is a rotational axis direction of the first discharge roller 1035 and the second discharge roller 1037. In addition, the sub-scanning direction also corresponds to the width direction of the sheet S. The slide rail 1012 is a rail that is formed on the support guide 1010C and extends in the sub-scanning direction. The fixed blade 1010A is a flat plate-shaped blade that is fixed to the support guide 1010C and extends in the sub-scanning direction. In the support guide 1010C, a space 1010D is formed by the slide rail 1012 and the fixed blade 1010A. The sheet S passes through the space 1010D formed by the slide rail 1012 and the fixed blade 1010A. The blade 1011 is a circular plate-shaped blade, and is rotatably fixed to the cutter carriage 1013.

The cutter carriage 1013 is engaged with the slide rail 1012, and is slidably attached to the support guide 1010C along the slide rail 1012. The cutter carriage 1013 is movable from an initial position indicated by a solid line to a cutting completion position indicated by a broken line in FIG. 20. Before the sheet S is cut, the cutter carriage 1013 is located at the initial position indicated by the solid line in FIG. 20. When the cutter carriage 1013 moves to the cutting completion position along the slide rail 1012, one sheet S is sandwiched between the fixed blade 1010A and the blade 1011 and is cut into the first sheet S1 and the second sheet S2.

The cutter 1010 cuts the sheet S by moving the cutter carriage 1013 in the sub-scanning direction using a rotational force of the cutting motor 1106. As a result, the sheet S is subjected to a cutting process by the fixed blade 1010A and the blade 1011, and the sheet S is completely divided into the first sheet S1 and the second sheet S2 that are located on the front and rear sides in the conveying direction.

The drive pulley 1014 is provided on the other side of the support guide 1010C in the sub-scanning direction, that is, on the right side in the left-right direction. The drive pulley 1014 can rotate in the forward and reverse directions by receiving a drive force of the cutting motor 1106. The driven pulley 1015 is provided on one side of the support guide 1010C in the sub-scanning direction. The pulley belt 1016 is wound around the drive pulley 1014 and the driven pulley 1015. Further, the cutter carriage 1013 is fixed to the pulley belt 1016.

As a result, the cutter carriage 1013 slides in the sub-scanning direction in accordance with the rotation of the pulley belt 1016. In detail, when the cutting motor 1106 is rotated in the forward direction, the cutter carriage 1013 slides from one side to the other side in the sub-scanning direction, and when the cutting motor 1106 is rotated in the reverse direction, the cutter carriage 1013 slides from the other side to one side in the sub-scanning direction.

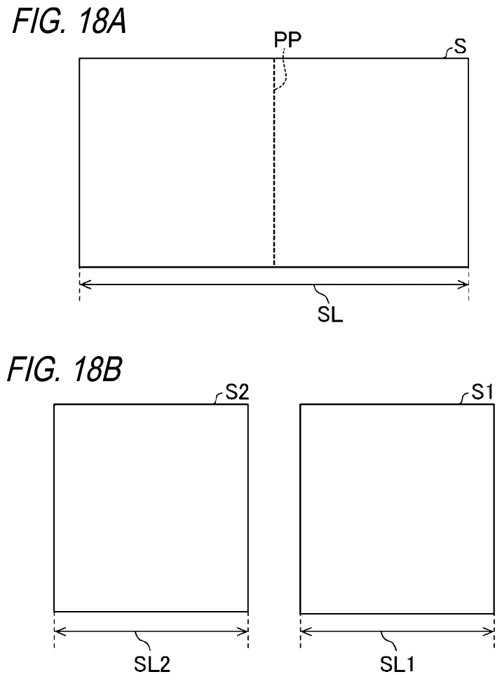

The cutting of the sheet S by the cutter 1010 will be described with reference to FIGS. 18A and 18B. FIGS. 18A and 18B are diagrams for explaining the cutting of the sheet S by the cutter 1010. FIG. 18A shows the sheet S that is not cut by the cutter 1010. FIG. 18B shows the first sheet S1 and the second sheet S2 that are cut by the cutter 1010. The length of the sheet S in the first conveying direction DR1 before the cutting is SL. Hereinafter, the length of the sheet S in the first conveying direction DR1 is simply referred to as a “sheet length” (the same also applies to the first sheet S1 and the second sheet S2 after the cutting). FIGS. 18A and 18B show examples in which the sheet S is divided into two equal portions by the cutter 1010.

When the expected cutting point PP of the sheet S shown in FIG. 18A is conveyed to the position of a cutting point C of the cutter 1010 shown in FIG. 16, the sheet S is cut by the cutter 1010. As shown in FIG. 18B, the sheet S is cut into the first sheet S1 that is a sheet on the upstream side in the first conveying direction DR1 after the cutting, and the second sheet S2 that is a sheet on the downstream side in the first conveying direction DR1 after the cutting. The first sheet S1 is the front half portion of the sheet after the cutting, and the second sheet S2 is the rear half portion of the sheet after the cutting. Each of a sheet length SL1 of the first sheet S1 and a sheet length SL2 of the second sheet S2 is ½ of the sheet length SL of the sheet S. For example, in the present embodiment, the sheet S having the A4 size (210 mm×297 mm) and the sheet S having the letter size (216 mm×279 mm) are set to be cuttable. Therefore, by cutting the sheet having the A4 size into two equal portions, the first sheet S1 and the second sheet S2 each having A5 size (210 mm×148 mm) are acquired. Further, the sheet S having the letter size forms the first sheet S1 and the second sheet S2 (216 mm×139 mm) after the cutting.

As shown in FIG. 16, a first stack lever 1040 is provided to be pivotable about a pivot shaft 1041 with respect to the apparatus main body 102. The first stack lever 1040 is located downstream of the first discharge roller 1035, and is provided in the vicinity of the first discharge port 1025. The first stack lever 1040 extends toward the placement surface 1023 of the discharge tray 1022, and can come into contact with the sheet S discharged to the discharge tray 1022 by the first discharge roller 1035. Further, the first stack lever 1040 can also come into contact with the sheet S placed on the placement surface 1023.

The first stack lever 1040 is movable between a lower limit position 1040A indicated by a solid line and an upper limit position 1040B indicated by a broken line. That is, a pivot range of the first stack lever 1040 is a range between the lower limit position 1040A and the upper limit position 1040B. The lower limit position 1040A is a lower extreme position in the pivot range of the first stack lever 1040. The upper limit position 1040B is an upper extreme position in the pivot range of the first stack lever 1040. The second discharge roller 1037 is disposed above the upper limit position 1040B.

A dispositional relation between the first stack lever 1040 and the placement surface 1023 of the discharge tray 1022 will be described with reference to FIG. 19. FIG. 19 is a view for explaining a dispositional relation between the placement surface 1023 of the discharge tray 1022 and the respective members in the vicinity of the first discharge port 1025 and the second discharge port 1026. FIG. 19 is a view of the respective members disposed in the vicinity of the first discharge port 1025 and the second discharge port 1026 as viewed from the front side of the image forming apparatus 1 toward the rear side. In FIG. 19, in order to make it easy to see the dispositional relation of the respective members, the apparatus main body 102 and respective members not used for describing the dispositional relation are not shown.

As shown in FIG. 19, in the present embodiment, one first stack lever 1040 is disposed at a position corresponding to a third end 1233 side as one side of the placement surface 1023 in the left-right direction, and the other stack lever 1040 (corresponding to a third stack lever) is disposed at a position corresponding to a fourth end 1234 side as the other side of the placement surface 1023 in the left-right direction. That is, the first stack levers 1040 are disposed to be capable of coming into contact with both ends of the sheet S discharged by the first discharge roller 1035 in the width direction.

As shown in FIG. 16, a second stack lever 1045 is provided to be pivotable about a pivot shaft 1046 with respect to the apparatus main body 102. The second stack lever 1045 is located downstream of the second discharge roller 1037, and is provided in the vicinity of the second discharge port 1026. The second stack lever 1045 extends toward the placement surface 1023 of the discharge tray 1022, and can come into contact with the first sheet S1 and the second sheet S2 discharged to the discharge tray 1022 by the second discharge roller.

As shown in FIG. 19, the second stack lever 1045 is disposed at a position corresponding to a central portion of the placement surface 1023. Therefore, it is possible to come into contact with central portions of the first sheet S1 and the second sheet S2 discharged by the second discharge roller 1037. A plurality of second stack levers 1045 may be provided.

As shown in FIG. 16, the first discharge port 1025 and the second discharge port 1026 are provided with static elimination brushes 1042 and 1047, respectively. The static elimination brushes 1042 and 1047 eliminate static electricity charged on the sheet by coming into contact with the sheet S. The static elimination brush 1042 is provided downstream of the first discharge roller 1035 and comes into contact with the sheet S discharged by the first discharge roller 1035. The static elimination brush 1047 is provided downstream of the second discharge roller 1037 and comes into contact with the sheet S discharged by the second discharge roller 1037. As shown in FIG. 19, the static elimination brushes 1042 and 1047 are disposed at positions corresponding to the central portion of the placement surface 1023. That is, the static elimination brush 1042 comes into contact with the central portion of the sheet S discharged by the first discharge roller 1035, and the static elimination brush 1047 comes into contact with the central portions of the first sheet S1 and the second sheet S2 discharged by the second discharge roller 1037.

As shown in FIG. 16, a pre-registration sensor 1110 is located between the separation roller 1031 and the registration roller 1033 in the first conveying direction DR1, and is located immediately in front of the registration roller 1033. The pre-registration sensor 1110 detects the presence or absence of the sheet S at a sensor location thereof, and outputs a signal corresponding to the presence or absence of the sheet S. Hereinafter, the output signal of the pre-registration sensor 1110 is turned on when the sheet S is present at the sensor location, and is turned off when the sheet S is not present at the sensor location.

A post-registration sensor 1111 is located between the registration roller 1033 and the photosensitive drum 1061 in the first conveying direction DR1. The post-registration sensor 1111 detects the presence or absence of the sheet S at a sensor location thereof, and outputs a signal corresponding to the presence or absence of the sheet S. Hereinafter, the output signal of the post-registration sensor 1111 is turned on when the sheet S is present at the sensor location, and is turned off when the sheet S is not present at the sensor location.

The discharge sensor 1112 is located between the fixing device 105 and the flapper 108 in the first conveying direction DR1. The discharge sensor 1112 detects the presence or absence of the sheet S at a sensor location thereof, and outputs a signal corresponding to the presence or absence of the sheet S. Hereinafter, the output signal of the discharge sensor 1112 is turned on when the sheet S is present at the sensor location, and is turned off when the sheet S is not present at the sensor location.

As the pre-registration sensor 1110, the post-registration sensor 1111, and the discharge sensor 1112, for example, a sensor provided with an actuator that swings when the sheet S comes into contact with the actuator, an optical sensor, or the like can be used.

The re-conveying path 1201 is a path through which the sheet having passed through the fixing device 105 is conveyed toward the image forming unit 104. In order to form an image on a back surface opposite to the surface (front surface) of the sheet S on which the image is formed by the fixing device 105, the sheet S passes through the re-conveying path 1201.

The re-conveying path 1201 is a path from a position 1201A downstream of the discharge sensor 1112 and upstream of the first discharge roller 1035 in the first conveying direction DR1 of the first conveying path 1200A to a position 1201B upstream of the pre-registration sensor 1110 in the first conveying direction DR1 of the conveying path 1200.

When the toner image is fixed on the back surface of the sheet S by using the re-conveying path 1201, the flapper 108 is located at the first position 108A and guides the sheet S toward the first discharge roller 1035. When the sheet S passes through the fixing device 105, the first discharge roller 1035 rotates in the reverse direction to convey the sheet S to the re-conveying path 1201. The re-conveying rollers 1038 and 1039 convey the sheet S along the re-conveying path 1201 by the drive force transmitted from the main motor 1108 (FIG. 17). In the re-conveying path 1201, the sheet S is conveyed in a second conveying direction DR2 opposite to the first conveying direction DR1.

### Electrical Configuration of Image Forming Apparatus

Next, an electrical configuration of the image forming apparatus 1 will be described with reference to FIG. 17. FIG. 17 is a block diagram showing the electrical configuration of the image forming apparatus 1. As shown in FIG. 17, the image forming apparatus 101 further includes an application specific integrated circuit (ASIC) 1105, a read only memory (ROM) 1102, a random access memory (RAM) 1103, a non-volatile random access memory (NVRAM) 1104, an electromagnetic clutch 1107, the main motor 1108, an operation panel 1120, a communication interface (I/F) 1130, and the discharging motor 1109.

The ASIC 1105 is mounted with a CPU 1101. The CPU 1101 performs general control for the respective parts of the image forming apparatus 101. The CPU 1101 and the ASIC 1105 are examples of the controller. The ROM 1102 stores various control programs and the like for controlling the image forming apparatus 101. The CPU 1101 executes a program using the RAM 1103 as a work area. The NVRAM 1104 stores settings of various processes of the image forming apparatus 101 and data used for the various processes.

The ASIC 1105 is electrically connected to the laser unit 107, the charger (not shown), the transfer roller TR, the heating roller 1051 and the temperature sensor 1054 of the fixing device 105, the electromagnetic clutch 1107 of the pickup roller 1030, the main motor 1108, the discharging motor 1109, the pre-registration sensor 1110, the post-registration sensor 1111, the discharge sensor 1112, a temperature and humidity sensor 1113, the operation panel 1120, the ROM 1102, the RAM 1103, the NVRAM 1104, the cutting motor 1106 of the cutter 1010, the flapper 108, and the communication interface (I/F) 1130.

The CPU 1101 acquires the output signals from the pre-registration sensor 1110, the post-registration sensor 1111, and the discharge sensor 1112. The CPU 1101 is connected to a LAN via the communication interface (I/F) 1130 and can communicate with an external information terminal located outside the image forming apparatus 101. The CPU 1101 can receive a print job from the external information terminal via the communication interface 1130.

The CPU 1101 may acquire the print job via an interface other than the communication interface 1130, for example, a USB interface. Further, the CPU 1101 may acquire a print command to fix the toner image on the sheet S based on a print job stored in the ROM 1102, the RAM 1103, or the NVRAM 1104 in response to an input via the operation panel 1120.

The CPU 1101 acquires information on the temperature of the heating roller 1051 from the temperature sensor 1054, and controls the heater 1053 to adjust the temperature of the heating roller 1051.

The CPU 1101 controls the cutting motor 1106. The cutting motor 1106 is a motor that transmits the drive force to the cutter carriage 1013 on which the blade 1011 of the cutter 1010 is mounted. The cutting motor 1106 is controlled by the CPU 1101, and the drive force of the cutting motor 1106 is transmitted to the cutter carriage 1013 to move the blade 1011 in the cutting direction.

The main motor 1108 transmits the drive force to the pickup roller 1030, the registration roller 1033, the re-conveying rollers 1038 and 1039, the pressure roller 1052, the photosensitive drum 1061, and the developing roller 1064.

The main motor 1108 is driven to rotate in the forward direction or rotate in the reverse direction under the control of the CPU 1101. When the main motor 1108 is driven to rotate in the forward direction, the pickup roller 1030, the registration roller 1033, the pressure roller 1052, the photosensitive drum 1061, and the developing roller 1064 can be rotated in the forward direction. When the pickup roller 1030, the registration roller 1033, the pressure roller 1052, the photosensitive drum 1061, and the first discharge roller 1035 rotate in the forward direction, the sheet S is conveyed along the conveying path 1200 in FIG. 16. When the developing roller 1064 rotates in the forward direction, the toner is fed to the electrostatic latent image formed on the surface of the photosensitive drum 1061.

When the main motor 1108 is driven to rotate in the reverse direction, the pickup roller 1030, the registration roller 1033, the pressure roller 1052, the photosensitive drum 1061, and the developing roller 1064 stop.

The re-conveying rollers 1038 and 1039 rotate in the reverse direction and convey the sheet S along the re-conveying path 1201 both when the main motor 1108 is driven to rotate in the forward direction and when the main motor 1108 is driven to rotate in the reverse direction.

The pickup roller 1030 includes the electromagnetic clutch 1107. The electromagnetic clutch 1107 is controlled by the CPU 1101. The CPU 1101 turns on the electromagnetic clutch 1107 so that the drive force of the main motor 1108 is transmitted to the pickup roller 1030. On the other hand, the CPU 1101 turns off the electromagnetic clutch 1107 so that the drive force of the main motor 1108 is not transmitted to the pickup roller 1030.

The CPU 1101 can control the discharging motor 1109. The drive force of the discharging motor 1109 is transmitted to the conveying roller 1036 and the second discharge roller 1037, and the sheet S is conveyed along the second conveying path 1200B. Further, the drive force of the discharging motor 1109 is transmitted to the first discharge roller 1035, and the sheet S is conveyed along the first conveying path 1200A. When the discharging motor 1109 rotates in the reverse direction, the first discharge roller 1035, the conveying roller 1036, and the second discharge roller 1037 rotate in the reverse direction.

The CPU 1101 controls the position of the flapper 108 by controlling the drive motor (not shown). More specifically, the CPU 1101 moves the flapper 108 to the first position 108A in order to convey the sheet S, on which the image is formed by the image forming unit 104 and which is not cut by the cutter 1010, to the first conveying path 1200A. Further, the CPU 1101 moves the flapper 108 to the second position 108B in order to convey the sheet S, on which the image is formed by the image forming unit 104 and which is cut by the cutter 1010, to the second conveying path 1200B.

The operation panel 1120 is disposed on an upper front outer surface of the apparatus main body 102. The operation panel 1120 is implemented by, for example, a touch panel. The user can perform an operation of changing the settings of the image forming apparatus 101, an operation of starting the image formation onto the sheet S, and the like by using the operation panel 1120. For example, the user can set a sheet type, a sheet size, and the like of the sheet S placed on the feed tray 1021 by operating the operation panel 1120. The sheet type of the sheet S refers to, for example, plain paper, thick paper, glossy paper, label paper, or an envelope. The sheet size of the sheet S refers to, for example, the A4 size, the A5 size, the letter size, the square type envelope NO. 2, the long type envelope NO. 3, or the like.

In addition, regarding a printing method, an operation of designating a printing condition such as one-sided printing in which the toner image is formed and fixed only on one side of the sheet S and double-sided printing in which the toner image is formed and fixed on both sides of the sheet S, and an operation of designating whether to cut the sheet S by the cutter 1010 can also be performed on the operation panel 1120. Further, it is possible to perform an operation of supporting a print command, that is, a print command to start printing according to the sheet type, the sheet size, and the printing method designated by the operation panel 1120. The operation panel 1120 may include a display device and a plurality of buttons.

### Dispositional Relation Between Discharge Tray and Second Discharge Roller

A dispositional relation between the discharge tray 1022 and the second discharge roller 1037 will be described with reference to FIG. 16. The second discharge roller 1037 is disposed above the placement surface 1023 of the discharge tray 1022. That is, when the image forming apparatus 101 is viewed from above, there is a dispositional relation in which the second discharge roller 1037 and the placement surface 1023 overlap in a discharge direction D3.

Here, a reference point 1024 on the placement surface located below the second discharge roller 1037 in the vertical direction is defined as follows. The reference point 1024 is a position corresponding to the lower side of the second discharge roller 1037 in the vertical direction in a normal use state in which the image forming apparatus 101 is placed on the horizontal plane. More specifically, in the normal use state in which the image forming apparatus 101 is placed on the horizontal plane, when the second discharge roller 1037 of the image forming apparatus 101 is projected toward the placement surface 1023 of the discharge tray 1022 from above in the vertical direction, an end point on the downstream side in the discharge direction D3 of a region projected on the placement surface 1023 is the reference point 1024. As indicated by a dashed line in FIG. 16, a virtual line VL extends in the vertical direction from an end portion on the downstream side in the discharge direction D3 of an outer diameter of the second discharge roller 1037. The reference point 1024 is an intersection of the virtual line VL and the placement surface 1023.

In the present embodiment, the reference point 1024 is determined by an outer diameter of the driven roller 1037B located below the drive roller 1037A of the second discharge roller 1037. When the drive roller 1037A is located below the driven roller 1037B, the reference point 1024 is determined by an outer diameter of the drive roller 1037A. Further, when a plurality of second discharge rollers 1037 are disposed, the second discharge roller located on the most downstream side in the discharge direction DR3 serves as a target.

The length N1 of a shortest distance in a direction along the placement surface 1023 from the first end 1231 of the placement surface 1023 to the reference point 1024 of the placement surface 1023 is smaller than the sheet length SL1 of the first sheet S1 and the sheet length SL2 of the second sheet S2 discharged from the second discharge roller 1037. That is, the second discharge roller 1037 is disposed such that the length N1 is smaller than the sheet length of the cut sheet. The sheet length of the cut sheet compared with the length N1 is a minimum sheet length of the cut sheet that can be discharged by the image forming apparatus 101. In the present embodiment, since the sheet acquired by cutting the sheet having the letter size into two equal portions corresponds to the minimum sheet length, the N1 is smaller than 139 mm.

Further, the length N2 in the discharge direction DR3 from the second discharge roller 1037 to the contact surface 1271 of the stopper 1027 is larger than the sheet length SL1 of the first sheet S1 and the sheet length SL2 of the second sheet S2 discharged by the second discharge roller 1037. More specifically, the length N2 is the length of a shortest distance from an end portion on the downstream side in the discharge direction DR3 of the outer diameter of the driven roller 1037B of the second discharge roller 1037 to the contact surface 1271. The second discharge roller 1037 is disposed such that the length N2 is larger than a maximum sheet length of the cut sheet.

### Operation and Effect of Embodiment 2

According to the image forming apparatus 101 of Embodiment 2, since the second discharge roller 1037 is located downstream of the first discharge roller 1035 in the discharge direction DR3, it is possible to easily take out the first sheet S1 and the second sheet S2 discharged to the discharge tray 1022 by discharging the first sheet S1 and the second sheet S2 after the cutting by the second discharge roller 1037. Further, on the placement surface 1023, the length N1 of the shortest distance from the first end 1231 on the first discharge roller 1035 side to the reference point 1024 is smaller than the sheet lengths SL1 and SL2 of the first sheet S1 and the second sheet S2. Therefore, it is possible to reduce the possibility that the first sheet S1 and the second sheet S2 discharged from the second discharge roller 1037 enter between the sheets already stacked on the discharge tray 1022. As a result, even when the cut sheet is discharged to the discharge tray 1022, the order of the discharged sheet can be prevented from being changed. Therefore, the discharge performance of the image forming apparatus 101 can be improved.

More specifically, there is the possibility that the first sheet S1 and the second sheet S2 discharged from the second discharge roller 1037 fall on the placement surface 1023 along the virtual line VL and then move along the inclined surface 1023A of the placement surface 1023 until the trailing ends of the sheets come into contact with the standing wall 1221. When the length N1 is larger than the sheet lengths SL1 and SL2 of the first sheet S1 and the second sheet S2 on the placement surface 1023, the trailing end of the first sheet S1 and/or the second sheet S2 may stop at the position of the reference point 1024. For example, in a case in which the trailing end of the second sheet S2 stops at the position of the reference point 1024 after the first sheet S1 discharged first moves to the standing wall 1221, the order of the sheet is changed when the user takes out the sheet, the second sheet S2 is taken out as a first sheet, and the first sheet S1 is taken out as a second sheet. In addition, in a case in which the discharged first sheet S1 and second sheet S2 move to the standing wall 1221 in a state in which a plurality of sheets S have already been discharged to the discharge tray 1022, even when the trailing end of the sheet S further discharged thereafter remains at the position of the reference point 1024, the order of the discharged sheet S, the first sheet S1, and the second sheet S2 is changed.

Further, in the image forming apparatus 101, the discharge tray 1022 may include the standing wall 1221 protruding upward from the first end 1231 of the placement surface 1023. According to the configuration in which the discharge tray 1022 includes the standing wall 1221, end portions of the discharged sheet S, the first sheet S1, and the second sheet S2 on a standing wall 1221 side can be brought into contact with the standing wall 1221. As a result, after the sheet S is discharged, the end portions of the sheet S, the first sheet S1, and the second sheet S2 on the standing wall 1221 side can be aligned.

Further, according to the configuration in which the placement surface 1023 has the inclined surface 1023A, the discharged sheet S, the first sheet S1, and the second sheet S2 can be moved toward a first end 1231 side along the placement surface 1023 due to the inclined surface 1023A. Therefore, the sheet S, the first sheet S1, and the second sheet S2 that have moved toward the first end 1231 side come into contact with the standing wall 1221 disposed at the first end 1231. As a result, the end portions of the sheet S, the first sheet S1, and the second sheet S2 placed on the discharge tray 1022 on the standing wall 1221 side can be aligned.

Further, according to the configuration in which the horizontal surface 1023B of the placement surface 1023 is located below the second discharge roller 1037, the horizontal surface 1023B of the placement surface 1023 formed on the second end 1232 side with respect to the inclined surface 1023A is located below the second discharge roller 1037. Therefore, a space can be formed between the second discharge roller 1037 and the placement surface 1023 of the discharge tray 1022. As a result, the first sheet S1 or the second sheet S2 jammed when the first sheet S1 or the second sheet S2 is jammed at the second discharge roller 1037 can be easily taken out.

According to the configuration including the first conveying path 1200A and the second conveying path 1200B, the sheet S after the image formation can be cut by the cutter 1010 and then discharged to the discharge tray 1022 by the second discharge roller 1037.

According to the configuration in which the second discharge roller 1037 is disposed above the upper limit position 1040B of the first stack lever 1040, even when the first stack lever 1040 pivots to the upper limit position 1040B of the pivot range with respect to the apparatus main body 102, the first stack lever 1040 does not interfere with the second discharge roller 1037. As a result, when the first sheet S1 and the second sheet S2 are discharged, the first stack lever 1040 can perform a normal operation without being restricted in operation.

According to the configuration in which the first stack lever 1040 is disposed on the third end 1233 side of the placement surface 1023 and the third stack lever 1040 is disposed on the fourth end 1234 side, both ends of the uncut sheet S after the discharge can be restrained by the first stack lever 1040 and the third stack lever 1040 in the width direction of the sheet as a direction orthogonal to the discharge direction DR3. As a result, it is possible to prevent the sheet S placed on the discharge tray 1022 from curling in the width direction.

According to the configuration in which the second stack lever 1045 is disposed at the position corresponding to the central portion of the placement surface 1023 in the width direction, it is possible to easily bring the cut first sheet S1 and second sheet S2 discharged by the second discharge roller 1037 into contact with the second stack lever 1045. Therefore, regarding the cut first sheet S1 and second sheet S2 after the discharge, although the sheet interval between the first sheet S1 as the front half portion of the sheet and the second sheet S2 as the rear half portion becomes small, the first sheet S1 can be discharged toward the discharge tray 1022 more quickly by the second stack lever 1045. As a result, it is possible to reduce the possibility that the first sheet S1 is pressed by the second sheet S2 and the order of the discharged sheet is changed.

According to the configuration in which the static elimination brush 1047 is provided, it is possible to eliminate the static electricity charged on the cut first sheet S1 and second sheet S2 discharged from the second discharge roller 1037. As a result, it is possible to prevent the plurality of first sheets S1 and second sheets S2 discharged to the discharge tray 1022 from being attracted to each other by the static electricity.

According to the configuration in which the length N2 from the second discharge roller 1037 to the contact surface 1271 of the stopper 1027 is larger than the maximum sheet length of the cut first sheet S1 and second sheet S2 after the discharge, the sheet S, the first sheet S1, and the second sheet S2 discharged by the first discharge roller 1035 and the second discharge roller 1037 come into contact with the stopper 1027, and thus it is possible to reduce the risk that the sheet S, the first sheet S1, and the second sheet S2 move to the outside of the discharge tray 1022. As a result, the sheet S, the first sheet S1, and the second sheet S2, which are discharged, can be stacked on the discharge tray 1022. In addition, it is possible to reduce the possibility that the sheet S, the first sheet S1, and the second sheet S2 which are discharged by the second discharge roller 1037 enter between the sheet S, the first sheet S1, and the second sheet S2 which are stacked. As a result, it is possible to prevent the order of the discharged sheet from being changed.

### Embodiment 3

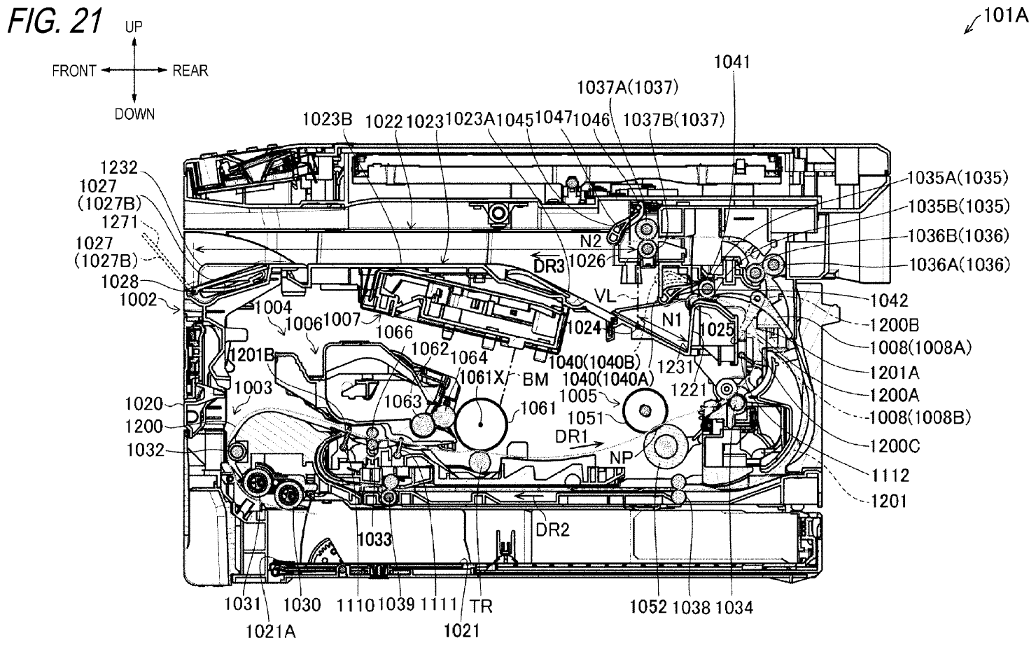

Other embodiments of the present disclosure will be described below with reference to FIG. 21. FIG. 21 is a diagram showing a schematic configuration of an image forming apparatus according to Embodiment 3 of the present disclosure. For convenience of description, members having the same functions as the members described in the above Embodiment 2 are denoted by the same reference symbols, and description thereof will not be repeated. An image forming apparatus 101A according to Embodiment 3 is different from the image forming apparatus 101 according to Embodiment 2 in that the cutter 1010 is not included.

The image forming apparatus 101A is an image forming apparatus that is capable of discharging the sheet S having a different sheet length in the first conveying direction DR1 as a direction in which the sheet S is conveyed. The image forming apparatus 101A changes the conveying path for conveying the sheet S according to the sheet length. More specifically, the image forming apparatus 101A conveys the sheet S to the first conveying path 1200A or the second conveying path 1200B according to the sheet length.

The image forming apparatus 101A includes a plurality of feed trays 1021. Sheets having different sheet lengths can be placed on each of the feed trays 1021. In FIG. 21, only one feed tray 1021 is shown, and other feed trays 1021 are not shown.

In the image forming apparatus 101A, the CPU 1101 moves the flapper 108 to the first position 108A in order to convey the sheet S, on which the image is formed by the image forming unit 104 and which has a sheet length larger than a predetermined sheet length, to the first conveying path 1200A. Further, the CPU 1101 moves the flapper 108 to the second position 108B in order to convey the sheet S, on which the image is formed by the image forming unit 104 and which has a sheet length equal to or smaller than the predetermined sheet length, to the second conveying path 1200B. Therefore, the sheet S having the sheet length larger than the predetermined sheet length is discharged to the discharge tray 1022 by the first discharge roller 1035, and the sheet S having the sheet length equal to or smaller than the predetermined sheet length is discharged to the discharge tray 1022 by the second discharge roller 1037.

The length N1 of the shortest distance in the direction along the placement surface 1023 from the first end 1231 of the placement surface 1023 of the discharge tray 1022 to the reference point 1024 of the placement surface 1023 is smaller than the length L3 in the first conveying direction DR1 from the second discharge roller 1037 to the conveying roller 1036. Therefore, the second discharge roller 1037 is disposed such that the length N1 is smaller than the minimum sheet length of the sheet S that can be discharged by the second discharge roller 1037. The length L3 also refers to the length in first conveying direction DR1 from a nip point between the drive roller 1036A and the driven roller 1036B of the conveying roller 1036 to a nip point between the drive roller 1037A and the driven roller 1037B of the second discharge roller 1037.

The length N2 is larger than the maximum sheet length of the sheet S that can be discharged by the second discharge roller 1037. That is, the length N2 is larger than the predetermined sheet length.

### Operation and Effect of Embodiment 3

According to the configuration of the image forming apparatus 101A of Embodiment 3, since the second discharge roller 1037 is located upstream of the first discharge roller 1035 in the discharge direction DR3, it is possible to easily take out the sheet S discharged to the discharge tray 1022 and having a short sheet length by discharging the sheet S having the short sheet length by the second discharge roller 1037. In addition, on the placement surface 1023 of the discharge tray 1022, the length N1 of the shortest distance from the first end 1231 on the first discharge roller 1035 side to the reference point 1024 is smaller than the length L3 in the first conveying direction DR1 from the second discharge roller 1037 to the conveying roller 1036 located at the position closest to the second discharge roller 1037 in the first conveying direction DR1. Therefore, it is possible to reduce the possibility that the sheet S discharged from the second discharge roller 1037 and having the short sheet length enters between the sheets S already stacked on the discharge tray 1022. As a result, even when the sheet S having the short sheet length is discharged to the discharge tray 1022, the order of the discharged sheet S can be prevented from being changed. Therefore, the discharge performance of the image forming apparatus 101A can be improved.

### Other Embodiments

In the above embodiments, the image forming apparatuses 101 and 101A are monochrome laser printers, and the image forming apparatuses 101 and 101A may be color laser printers. Further, in the case of the color laser printer, a configuration including an intermediate transfer belt and a transfer roller that transfers a toner image on the intermediate transfer belt to a sheet may be adopted. Further, the image forming apparatuses 101 and 101A may be ink-jet type printers that eject ink to form an image.

In addition, in the above embodiments, the configuration in which the placement surface 1023 of the discharge tray 1022 includes the inclined surface 1023A and the horizontal surface 1023B is disclosed, but the present disclosure is not limited to such a configuration. The placement surface 1023 may be implemented by only an inclined surface, and may be implemented by only a horizontal surface.

In addition, in the above embodiments, the configuration in which the discharge tray 1022 includes the standing wall 1221 is disclosed, but the present disclosure is not limited to such a configuration. The discharge tray 1022 may not include the standing wall 1221.

In addition, in the above embodiments, the fact that each of the first discharge roller 1035, the conveying roller 1036, and the second discharge roller 1037 includes the drive roller and the driven roller is disclosed, but the present disclosure is not limited thereto. At least one of the first discharge roller 1035, the conveying roller 1036, and the second discharge roller 1037 may be implemented by only a drive roller.

Further, in the above embodiments, the configuration in which the cutter 1010 as the cutting mechanism cuts the sheet S by moving the blade 1011 in the cutting direction is disclosed, but the present disclosure is not limited thereto. For example, a configuration in which two blades longer than the width of the sheet S operate in the up-down direction to sandwich and cut the sheet, such as scissors, may be adopted. Further, a configuration in which one blade moving substantially perpendicular to the surface of the sheet S, that is, moving in the up-down direction and longer than the width of the sheet S is included, for example, a configuration including a guillotine type blade may be adopted.

The elements described in the above embodiments and modifications may be implemented in any combination.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image forming apparatus comprising:
an apparatus main body;
a cutter capable of cutting sheets;
a first discharge roller configured to discharge a sheet, which is not cut by the cutter, to the outside of the apparatus main body; and
a second discharge roller configured to discharge a sheet, which is cut by the cutter, to the outside of the apparatus main body, wherein
the second discharge roller is located downstream of the first discharge roller in a discharge direction of the sheet from the first discharge roller.

2. An image forming apparatus comprising:
an apparatus main body;
a cutter capable of cutting sheets;
a first discharge port through which a sheet that is not cut by the cutter is discharged to the outside of the apparatus main body; and
a second discharge port through which a sheet that is cut by the cutter is discharged to the outside of the apparatus main body, wherein
the second discharge port is located downstream of the first discharge port in a discharge direction of the sheet discharged from the first discharge port.

3. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes; and
a second conveying path different from the first conveying path and configured to guide the sheet on which the image is formed by the image forming unit to the outside of the apparatus main body, and through which the sheet that is cut by the cutter passes, wherein
the cutter is disposed in the second conveying path.

4. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes; and
a second conveying path different from the first conveying path and configured to guide the sheet on which the image is formed by the image forming unit to the outside of the apparatus main body, and through which the sheet that is cut by the cutter passes, wherein the second conveying path is a conveying path longer than the first conveying path.

5. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes;
a second conveying path different from the first conveying path and configured to guide the sheet on which the image is formed by the image forming unit to the outside of the apparatus main body, and through which the sheet that is cut by the cutter passes;
a fixing unit including a heating rotation body and a pressure rotation body that forms a nip portion between the heating rotation body and the pressure rotation body, and configured to fix the image onto the sheet; and
a flapper movable between a first position at which the sheet that has passed through the fixing unit is guided to the first conveying path and a second position at which the sheet that has passed through the fixing unit is guided to the second conveying path.

6. The image forming apparatus according to claim 1, further comprising:
a fixing unit including a heating rotation body and a pressure rotation body that forms a nip portion between the heating rotation body and the pressure rotation body, and configured to fix an image onto the sheet, wherein
the first discharge roller is located closer to the fixing unit than the second discharge roller.

7. The image forming apparatus according to claim 2, further comprising:
a fixing unit including a heating rotation body and a pressure rotation body that forms a nip portion between the heating rotation body and the pressure rotation body, and configured to fix an image onto the sheet, wherein
the first discharge port is located closer to the fixing unit than the second discharge port.

8. The image forming apparatus according to claim 1, further comprising:
a conveying roller located upstream of the cutter in a conveying direction of the sheet and configured to convey the sheet to the cutter, wherein
dimensions of the second discharge roller and the conveying roller in an axial direction are larger than half a width of a sheet having a maximum width and capable of being conveyed by the image forming apparatus.

9. The image forming apparatus according to claim 8, wherein
the dimension of at least one of the second discharge roller and the conveying roller in the axial direction is larger than the width of the sheet having the maximum width and capable of being conveyed by the image forming apparatus.

10. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes;
a second conveying path different from the first conveying path and configured to guide the sheet on which the image is formed by the image forming unit to the outside of the apparatus main body, and through which the sheet that is cut by the cutter passes;
a sensor disposed in a sheet conveying path and capable of detecting the presence or absence of the sheet; and
a controller, wherein
the controller acquires a dimension of the sheet in a conveying direction based on a detection signal from the sensor, and conveys the sheet to the second conveying path and discharges the sheet to the outside of the apparatus main body without cutting the sheet when determining that the dimension of the sheet in the conveying direction is smaller than a predetermined value.

11. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes;
a second conveying path different from the first conveying path and configured to guide the sheet on which the image is formed by the image forming unit to the outside of the apparatus main body, and through which the sheet that is cut by the cutter passes; and
a controller, wherein
when determining that a dimension of a sheet included in a received print job in a conveying direction of the sheet is smaller than a predetermined value, the controller conveys the sheet to the second conveying path and discharges the sheet to the outside of the apparatus main body without cutting the sheet.

12. The image forming apparatus according to claim 1, further comprising:
an image forming unit disposed in the apparatus main body and configured to form an image on the sheet;
a first conveying path configured to guide the sheet on which the image is formed by the image forming unit to the outside of the apparatus main body, and through which the sheet that is not cut by the cutter passes;
a second conveying path different from the first conveying path and configured to guide the sheet on which the image is formed by the image forming unit to the outside of the apparatus main body, and through which the sheet that is cut by the cutter passes;
a first discharge tray on which the sheet discharged through the first conveying path is allowed to stack; and
a second discharge tray on which the sheet discharged through the second conveying path is allowed to stack.

13. The image forming apparatus according to claim 3, wherein
the image forming unit includes a photosensitive drum, a developing roller that supplies a toner onto the photosensitive drum, and a transfer roller that transfers the toner supplied onto the photosensitive drum to the sheet.

14. An image forming apparatus comprising:
an image forming unit configured to form an image on a sheet;
a discharge tray configured to receive the sheet on which the image is formed;
a cutter capable of cutting the sheet on which the image is formed by the image forming unit;
a first conveying path configured to guide the sheet on which the image is formed by the image forming unit, and through which a sheet that is not cut by the cutter passes;
a first discharge roller disposed in the first conveying path and configured to discharge the uncut sheet to the discharge tray;
a second conveying path in which the cutter is disposed, configured to guide the sheet on which the image is formed by the image forming unit, and through which a sheet that is cut by the cutter passes; and
a second discharge roller disposed in the second conveying path and configured to discharge the cut sheet to the discharge tray, wherein
an upstream end of the sheet discharged from the second discharge roller in a discharge direction is located downstream in the discharge direction with respect to an upstream end of the sheet discharged from the first discharge roller in the discharge direction.

15. The image forming apparatus according to claim 1, further comprising:
a discharge tray on which the sheets discharged from the first discharge roller and the second discharge roller are stacked, wherein
the discharge tray has a placement surface on which the discharged sheets are placed, and
the length of a shortest distance in a direction along the placement surface from a first end of the placement surface on an upstream side in the discharge direction to a reference point of the placement surface located below the second discharge roller in a vertical direction is smaller than a sheet length of the sheet discharged from the second discharge roller.

16. The image forming apparatus according to claim 15, further comprising:
a standing wall protruding upward from the first end of the placement surface,
wherein the placement surface has an inclined surface formed between the first end and a second end opposite to the first end such that the first end is located below the second end.

17. The image forming apparatus according to claim 16, wherein
the placement surface has a horizontal surface formed on a second end side with respect to the inclined surface, and
the horizontal surface is located below the second discharge roller.

18. The image forming apparatus according to claim 15, further comprising:
a first conveying path in which the first discharge roller is disposed and configured to guide a sheet on which an image is formed to the first discharge roller; and
second conveying path in which the second discharge roller and the cutter is disposed and configured to guide the sheet on which the image is formed to the second discharge roller.

19. The image forming apparatus according to claim 15, further comprising:
a first stack lever that is pivotally provided, extends toward the placement surface, and is capable of coming into contact with the sheet discharged to the discharge tray by the first discharge roller; and
a second stack lever that is pivotally provided, extends toward the placement surface, and is capable of coming into contact with the sheet discharged to the discharge tray by the second discharge roller, wherein
the second discharge roller is disposed above an upper limit position that is an upper extreme position in a pivot range of the first stack lever.

20. The image forming apparatus according to claim 15, wherein
the reference point of the placement surface is an end point on a downstream side in the discharge direction in a region projected on the placement surface when the second discharge roller is projected toward the placement surface from above in the vertical direction.
